(19) United States
(12) Patent Application Publication
(10) Pub. No.: US 2020/0086793 A1
(43) Pub. Date: Mar. 19, 2020

(54) PERIPHERY MONITORING DEVICE

(71) Applicant: AISIN SEIKI KABUSHIKI KAISHA, Kariya-shi, Aichi (JP)

(72) Inventors: Kazuya WATANABE, Anjo-shi, Aichi-ken (JP); Tetsuya MARUOKA, Okazaki-shi, Aichi-ken (JP); Yuichi INOUE, Aichi-gun, Aichi-ken (JP); Yoko SAKAMOTO, Kariya-shi, Aichi-ken (JP)

(73) Assignee: AISIN SEIKI KABUSHIKI KAISHA, Kariya-shi, Aichi (JP)

(21) Appl. No.: 16/617,779

(22) PCT Filed: Feb. 22, 2018
(86) PCT No.: PCT/JP2018/006590

§ 371 Date: Nov. 27, 2019

(30) Foreign Application Priority Data
Jun. 2, 2017 (JP) 2017-110347

(51) Int. Cl. B60R 1/00; H04N 5/225; H04N 5/272; G06T 11/00

(52) U.S. Cl. CPC B60R 1/00; H04N 5/2253; B60R 2300/8086; G06T 11/00; B60R 2300/304; H04N 5/272

(57) ABSTRACT

A periphery monitoring device includes, for example, an acquirer and a controller. The acquirer acquires a vehicle image of the vehicle and a peripheral image representing peripheral situation of a vehicle based on image data output from an imager mounted on the vehicle to image the surroundings of the vehicle, and to be displayed in an overhead mode. The vehicle image is to be displayed on the peripheral image in the overhead mode. The controller causes a virtual vehicle image to be displayed on the peripheral image together with the vehicle image. The virtual vehicle image represents, in the overhead mode, a state of the vehicle when traveling at a current steering angle.

### TECHNICAL FIELD

An embodiment of the present invention relates to a periphery monitoring device.

### BACKGROUND ART

Conventionally, periphery monitoring devices are developed, which display, on a display in the interior of a vehicle, an image of the surroundings of the vehicle generated by an on-vehicle imaging device (for example, a camera) to provide the driver on a driver's seat with the situation around. One example of such a periphery monitoring device facilitates a driver's determination on whether the corner of the vehicle body comes into contact with a peripheral object by displaying, on an overhead image, an estimated trajectory indicating the passage of the corner while the vehicle turns in a small space such as a parking lot.

### CITATION LIST

### Patent Literature

Patent Document 1: Japanese Laid-open Patent Application No. 2012-66616

### SUMMARY OF INVENTION

### Problem to be Solved by the Invention

Such a conventional technique enables the driver to relatively easily determine whether each of the corners comes into contact with any object in the surroundings. However, while the vehicle travels forward, such a determination is to be comprehensively made as to whether all the corners can pass at the same timing with no contact with the object. The conventional system that displays an estimated trajectory requires the driver's experience and skills to intuitively determine how the vehicle behaves during traveling, or to determine whether the vehicle as a whole comes no contact with an object.

An object of the present invention is to provide a periphery monitoring device that enables a driver to determine how the vehicle behaves during traveling, or to more intuitively determine whether the vehicle as a whole comes no contact with the object.

### Means for Solving Problem

According to one embodiment of the present invention, for example, a periphery monitoring device includes an acquirer and a controller. The acquirer acquires a vehicle image of the vehicle and a peripheral image. The vehicle image is to be displayed on the peripheral image in the overhead mode. The peripheral image represents peripheral situation of a vehicle based on image data output from an imager mounted on the vehicle to image the surroundings of the vehicle, and is to be displayed in an overhead mode. The controller causes a virtual vehicle image to be displayed on the peripheral image together with the vehicle image. The virtual vehicle image represents, in the overhead mode, a state of the vehicle when traveling at a current steering angle. With this configuration, for example, the periphery monitoring device displays, on an overhead image, the vehicle image and the virtual vehicle image representing the state of the vehicle when traveling at the current steering angle, to present the relationship between the traveling vehicle and the surroundings, such as the one between the virtual vehicle image and an object located around the vehicle. Thus, the periphery monitoring device can provide display in such a manner that the user (driver) can intuitively recognize the relationship between the surroundings and the vehicle during traveling.

The controller of the periphery monitoring device causes the virtual vehicle image to be displayed such that the virtual vehicle image travels away from the vehicle image in a direction corresponding to the current steering angle of the vehicle from a superimposed position of the virtual vehicle image and the vehicle image. With this configuration, for example, the periphery monitoring device can display in advance change in the relationship between the surroundings and the vehicle when continuously traveling at the current steering angle, which enables the user to more intuitively recognize the behavior of the vehicle and the positional relationship with respect to the object during traveling.

The controller of the periphery monitoring device, for example, changes orientation of the virtual vehicle image with respect to the vehicle image so as to correspond to orientation of the vehicle traveling at the current steering angle while causing the virtual vehicle image and the vehicle image to be displayed at the superimposed position. With this configuration, the periphery monitoring device displays a future direction of the vehicle. Thus, the periphery monitoring device can provide display to allow the user to intuitively recognize behavior (posture, orientation) of the vehicle when traveling at the current steering angle, and easily understand a current steering direction. For example, in the case that the vehicle is coupled to a towed vehicle, the user can easily estimate the behavior of the towed vehicle by recognizing the behavior of the vehicle.

The acquirer of the periphery monitoring device acquires positional information indicating a position of an object to watch for located around the vehicle, and the controller sets a display stop position of the virtual vehicle image in accordance with the position of the object to watch for, for example. With this configuration, the periphery monitoring device stops moving the virtual vehicle image at the time of or immediately before interfering with an object to watch for, for example, an obstacle (such as another vehicle, a wall, a pedestrian), if it occurs during the vehicle traveling at the current steering angle, thereby making it possible to draw attention of the user.

The controller of the periphery monitoring device sets a display mode of the virtual vehicle image in accordance with a distance to the object to watch for. With this configuration, for example, the periphery monitoring device can further ensure that the user recognizes the presence of the object to watch for.

The acquirer of the periphery monitoring device acquires a coupling state of a towed vehicle towed by the vehicle with respect to the vehicle, and the controller causes the virtual vehicle image to be displayed on the peripheral image together with a coupling image representing the coupling state of the towed vehicle, for example. With this configuration, for example, the periphery monitoring device can concurrently display the coupling image of the towed vehicle and the virtual vehicle image, to enable the user to easily recognize from a future moving state or orientation of the virtual vehicle image how the state of the coupled towed vehicle (coupling angle) is changed due to the traveling of the towing vehicle (for example, backward travel).

The controller of the periphery monitoring device causes the virtual vehicle image to be displayed, after start of traveling of the vehicle, for example. With this configuration, for example, the periphery monitoring device can avoid continuously displaying the virtual vehicle image to simplify an image display during vehicle stop, and display the relationship between the vehicle and the surroundings in the future while gradually moving the vehicle, as needed. That is, the user can understand a future moving route while gradually driving the vehicle, and easily choose an appropriate moving route in accordance with the most recent surrounding environment.

When the current steering angle of the vehicle corresponds to a steering neutral position, the controller of the periphery monitoring device causes the virtual vehicle image not to be displayed. With this configuration, the periphery monitoring device enables the user to intuitively recognize from a display state of the display device that the current steering angle corresponds to a steering neutral position, that is, the vehicle is movable forward substantially straight. Additionally, the periphery monitoring device can simplify the peripheral image in an overhead mode, making it possible for the user to easily understand peripheral situation.

### BRIEF DESCRIPTION OF DRAWINGS

FIG. 1 is a perspective view of a vehicle equipped with a periphery monitoring device according to an embodiment with part of a vehicle interior transparent, by way of example;

FIG. 2 is a plan view of the exemplary vehicle equipped with the periphery monitoring device according to the embodiment;

FIG. 3 is a diagram illustrating an exemplary dashboard of the vehicle equipped with the periphery monitoring device according to the embodiment, as viewed from the vehicle rear;

FIG. 4 is a block diagram illustrating an exemplary image control system including the periphery monitoring device according to the embodiment;

FIG. 5 is a block diagram illustrating an exemplary configuration of a CPU in an ECU of the periphery monitoring device according to the embodiment, the CPU for implementing display of a virtual vehicle image;

FIG. 6 is a diagram illustrating an exemplary display of the virtual vehicle image by the periphery monitoring device according to the embodiment in a first display mode that the virtual vehicle image travels away from a vehicle image, when an object to watch for is not located around the vehicle;

FIG. 7 is a diagram illustrating an exemplary display of the virtual vehicle image by the periphery monitoring device according to the embodiment in the first display mode that the virtual vehicle image travels away from a vehicle image, when an object to watch for is located around the vehicle;

FIG. 8 is a diagram of a modification of FIG. 7 illustrating an example of displaying a stop line for highlighting a stop when the virtual vehicle image approaches an object to watch for (for example, another vehicle);

FIG. 9 is a diagram illustrating an exemplary display of the virtual vehicle image by the periphery monitoring device according to the embodiment in a second display mode that the virtual vehicle image turns to a direction corresponding to a direction of the virtual vehicle image when traveling while the vehicle image and the virtual vehicle image overlap with each other;

FIG. 10 is a diagram of a modification of FIG. 9, illustrating an example of searching the virtual vehicle image displayed in the second display mode for the steering angle to park the vehicle between parked vehicles;

FIG. 11 is a diagram of a modification of FIG. 9, illustrating an example of estimating the behavior of a towed vehicle from the virtual vehicle image displayed in the second display mode during backward traveling of the vehicle towing the towed vehicle;

FIG. 12 illustrates timing at which the vehicle comes in contact with another vehicle (an object to watch for) while the vehicle turns at a current steering angle in the periphery monitoring device according to the embodiment;

FIG. 13 is a diagram illustrating an exemplary display of the virtual vehicle image when the periphery monitoring device according to the embodiment operates in a parking assistance mode;

FIG. 14 is a flowchart of exemplary of display processing to the virtual vehicle image performed by the periphery monitoring device according to the embodiment;

FIG. 15 is a part of the flowchart of FIG. 14, illustrating exemplary display processing for displaying the virtual vehicle image in the parking assistance mode;

FIG. 16 is a diagram of another exemplary display of the virtual vehicle in the first display mode by the periphery monitoring device according to the embodiment;

FIG. 17 is a diagram of an exemplary display of the overhead image by the periphery monitoring device according to the embodiment when a current steering angle of the vehicle corresponds to a steering neutral position;

FIG. 18 is a diagram illustrating an exemplary application of the virtual vehicle image of the periphery monitoring device according to the embodiment for braking control over the vehicle, depicting an example that the virtual vehicle image stops at a stop line; and

FIG. 19 is a diagram illustrating an exemplary display different from FIG. 18, illustrating an example that the virtual vehicle image stops beyond the stop line.

### DESCRIPTION OF EMBODIMENTS

Hereinafter, exemplary embodiments of the present invention are disclosed. Configurations of the embodiments below, and operations, results, and effects attained by the configurations are merely exemplary. The present invention can be implemented by configurations other than the configurations disclosed in the following embodiments, and can attain at least one of various effects based on the basic configurations and derivative effects.

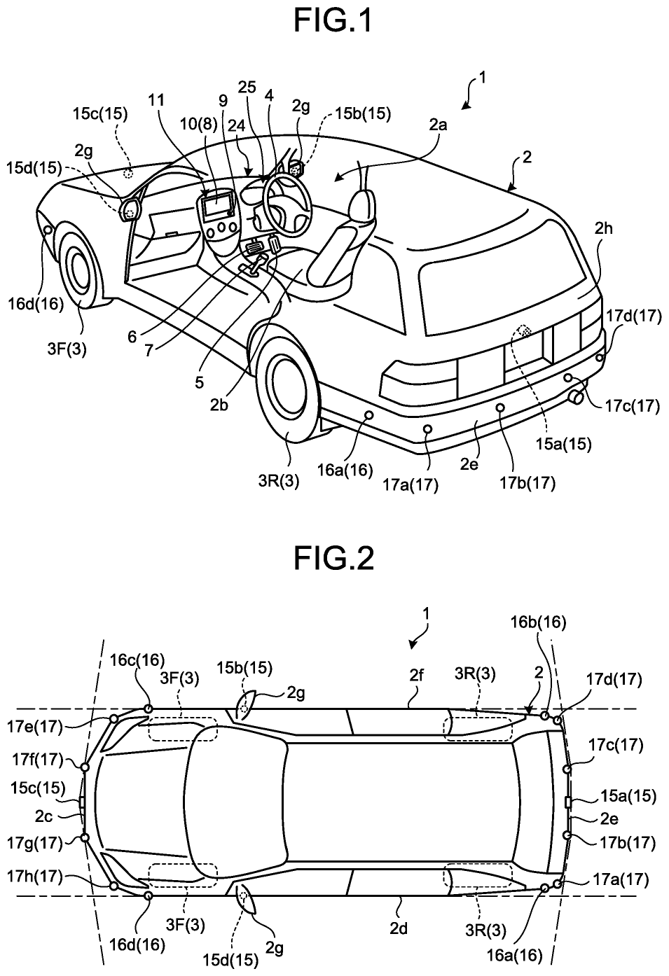

As illustrated in FIG. 1, in the present embodiment, a vehicle 1 incorporating a periphery monitoring device (periphery monitoring system) may be, for example, an automobile including an internal combustion engine (not illustrated) as a power source, that is, an internal combustion engine automobile, or an automobile including an electric motor (not illustrated) as a power source, that is, an electric automobile or a fuel battery automobile. The vehicle 1 may also be a hybrid automobile including both of the internal combustion engine and the electric motor as power sources, or an automobile including another power source. The vehicle 1 can incorporate various transmissions, and various devices required for driving the internal combustion engine and the electric motor, for example, systems or parts and components. The vehicle 1 may also be, for example, suitable for off-road driving (mainly on an unpaved uneven road) in addition to on-road driving (mainly on a paved road or a road equivalent thereto). As a driving system, the vehicle 1 can be a four-wheel-drive vehicle which transmits driving force to all of four wheels 3, and uses all the four wheels as driving wheels. Methods, the number, layouts, and else of devices involving with the driving of the wheel 3 can be variously set. For example, the vehicle 1 may be a vehicle intended mainly for on-road driving. The driving system is not limited to a four-wheel driving, and may be, for example, a front wheel driving or a rear wheel driving.

A vehicle body 2 defines a vehicle interior 2a where an occupant (not illustrated) rides. The vehicle interior 2a is provided with a steering 4, an accelerator 5, a braking unit 6, and a gearshift 7, facing a seat 2b of a driver as an occupant. The steering 4 is, for example, a steering wheel projecting from a dashboard 24, the accelerator 5 is, for example, an accelerator pedal located under a foot of the driver. The braking unit 6 is, for example, a brake pedal located under a foot of the driver. The gearshift 7 is, for example, a shift lever projecting from a center console. The steering 4, the accelerator 5, the braking unit 6, and the gearshift 7 are not limited thereto.

The vehicle interior 2a is provided with a display device 8 serving as a display output and a voice output device 9 serving as a voice output. Examples of the display device 8 include a liquid crystal display (LCD) and an organic electroluminescent display (OELD). The voice output device 9 is, for example, a speaker. The display device 8 is, for example, covered with a transparent operation input 10 such as a touch panel. The display device 8 is covered by a transparent operation input 10 such as a touch screen. The occupant can view images displayed on the screen of the display device 8 through the operation input 10. The occupant can also touch, press, and move the operation input with his or her finger or fingers at positions corresponding to the images displayed on the screen of the display device for executing operational inputs. The display device 8, the voice output device 9, and the operation input 10 are, for example, included in a monitor 11 disposed in the center of the dashboard 24 in the vehicle width direction, that is, transverse direction. The monitor 11 can include an operation input (not illustrated) such as a switch, a dial, a joystick, and a push button. Another voice output device (not illustrated) may be disposed in the vehicle interior 2a at a different location from the monitor 11 to be able to output voice from the voice output device 9 of the monitor 11 and another voice output device. For example, the monitor 11 can double as a navigation system and an audio system.

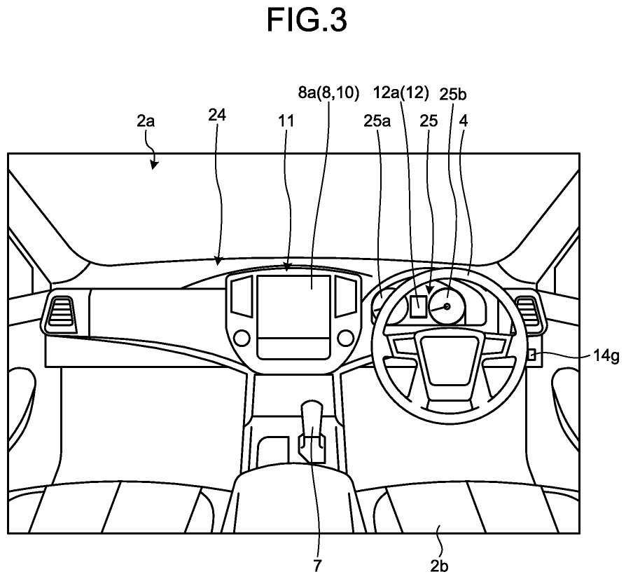

In the vehicle interior 2a, a display device 12 different from the display device 8 is also disposed. As illustrated in FIG. 3, the display device 12 is located in an instrument panel 25 of the dashboard 24 between a speed indicator 25a and a rotation-speed indicator 25b substantially at the center of the instrument panel 25. A screen 12a of the display device 12 is smaller in size than a screen 8a of the display device 8. The display device 12 can display, for example, an image representing an indicator, a mark, and text information as auxiliary information while a peripheral monitoring function or another function of the vehicle 1 is in operation. Information displayed by the display device 12 may be smaller in amount than information displayed by the display device 8. Examples of the display device 12 include an LCD and an OELD. The display device 8 may display information displayed on the display device 12.

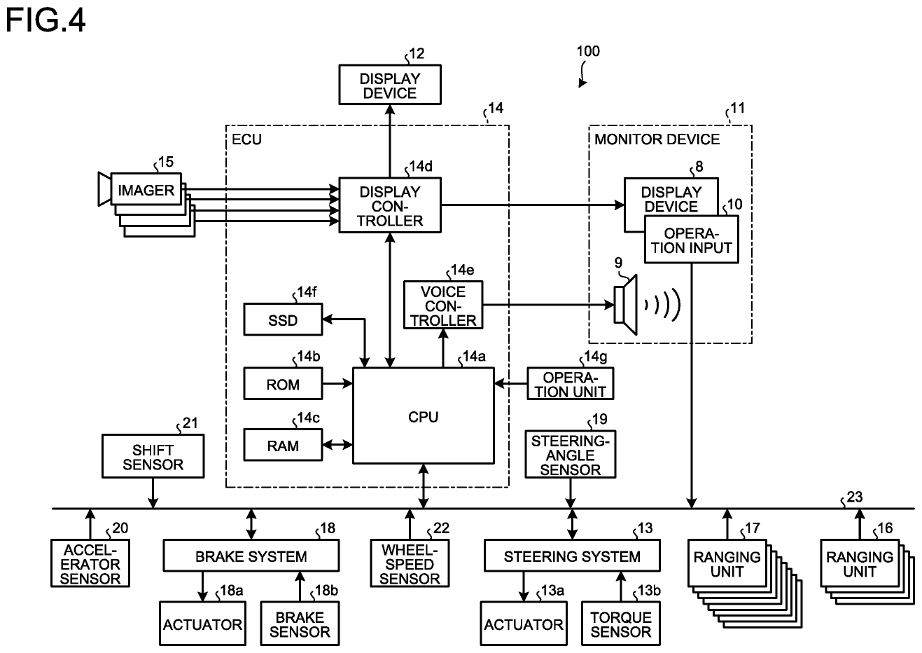

As illustrated in FIG. 1 and FIG. 2, the vehicle 1 represents, for example, a four-wheel automobile including two right and left front wheels 3F and two right and left rear wheels 3R. The four wheels 3 may be all steerable. As illustrated in FIG. 4, the vehicle 1 includes a steering system 13 to steer at least two of the wheels 3. The steering system 13 includes an actuator 13a and a torque sensor 13b. The steering system 13 is electrically controlled by, for example, an electronic control unit (ECU) 14 to drive the actuator 13a. Examples of the steering system 13 include an electric power steering system and a steer-by-wire (SBW) system. The torque sensor 13b detects, for example, torque applied to the steering 4 by the driver.

As illustrated in FIG. 2, the vehicle body 2 is equipped with a plurality of imagers 15, for example, four imagers 15a to 15d. Examples of the imagers 15 include a digital camera incorporating image sensors such as a charge coupled device (CCD) and a CMOS image sensor (CIS). The imagers 15 can output video data (image data) at a certain frame rate. Each of the imagers 15 includes a wide-angle lens or a fisheye lens and can photograph the horizontal range of, for example, from 140 to 220 degrees. The optical axes of the imagers 15 may be inclined obliquely downward. The imagers 15 sequentially generate images of the outside environment around the vehicle 1 including non-three-dimensional objects such as stop lines, parking lines, and section lines drawn on the road surface where the vehicle 1 is movable, and objects (such as three-dimensional obstacles, e.g., a wall, a tree, a person, a bicycle, and a vehicle) around the vehicle 1, and outputs the images as image data.

The imager 15a is, for example, located at a rear end 2e of the vehicle body 2 on a wall of a hatch-back door 2h under the rear window. The imager 15b is, for example, located at a right end 2f of the vehicle body 2 on a right side mirror 2g. The imager 15c is, for example, located at the front of the vehicle body 2, that is, at a front end 2c of the vehicle body 2 in vehicle length direction on a front bumper or a front grill. The imager 15d is, for example, located at a left end 2d of the vehicle body 2 on a left side mirror 2g in vehicle width direction. The ECU 14 can perform computation and image processing on image data generated by the imagers 15, thereby creating an image at wider viewing angle and a virtual overhead image of the vehicle 1 from above. The ECU 14 performs computation and image processing on wide-angle image data (curved image data) generated by the imagers 15 to correct distortion or generate a cutout image of a particular area. The ECU 14 can perform viewpoint conversion to convert image data into virtual image data imaged at a virtual viewpoint different from the viewpoint of the imagers 15. For example, the ECU 14 can convert image data into virtual image data of side-view image representing the side surface of the vehicle 1 as viewed away from the vehicle 1. The ECU 14 causes the display device 8 to display the generated image data to provide peripheral monitoring information for allowing the driver to conduct safety check of the right and left sides of the vehicle 1 and ahead of, behind and around the vehicle 1 while viewing the vehicle 1 from above.

The ECU 14 can perform driver assistance by identifying a section line drawn on the road surface around the vehicle 1 from the image data generated by the imagers 15, or perform parking assistance by detecting (extracting) a parking lot (section lines).

As illustrated in FIG. 1 and FIG. 2, the vehicle body 2 includes, for example, four ranging units 16a to 16d and eight ranging units 17a to 17h as a plurality of ranging units 16 and 17. The ranging units 16 and 17 are, for example, sonar that emits ultrasonic waves and receives reflected waves thereof. The sonar may also be referred to as a sonar sensor, an ultrasonic detector, or an ultrasonic sonar. In the present embodiment, the ranging units 16 and 17 are located at a low position along the height of the vehicle 1, for example, on front and rear bumpers. The ECU 14 can determine presence or absence of an object such as an obstacle around the vehicle 1, or measure a distance to the object from a result of the detection by the ranging units 16 and 17. That is, the ranging units 16 and 17 are an exemplary detector that detects an object. The ranging units 17 may be used in detecting an object in a relatively short distance while the ranging units 16 may be used in detecting an object in a relatively long distance, longer than that of the ranging unit 17, for example. The ranging units 17 may be used in detecting an object ahead of or behind the vehicle 1, for example. The ranging units 16 may be used in detecting an object on the lateral side of the vehicle 1.

As illustrated in FIG. 4, a periphery monitoring system 100 (periphery monitoring device) includes the ECU 14, the monitor device 11, the steering system 13, the ranging units 16 and 17, a brake system 18, a steering angle sensor 19, an accelerator sensor 20, a shift sensor 21, and a wheel-speed sensor 22 in electrical connection with one another via an in-vehicle network 23 serving as an electric communication line. The in-vehicle network 23 is, for example, configured as a controller area network (CAN). The ECU 14 can control the steering system 13 and the brake system 18 by transmitting a control signal thereto via the in-vehicle network 23. The ECU 14 can receive results of the detection from the torque sensor 13b, a brake sensor 18b, the steering angle sensor 19, the ranging units 16 and 17, the accelerator sensor 20, the shift sensor 21, and the wheel-speed sensor 22 as well as an operation signal from the operation input 10 via the in-vehicle network 23.

The ECU 14 includes, for example, a central processing unit (CPU) 14a, a read only memory (ROM) 14b, a random access memory (RAM) 14c, a display controller 14d, a voice controller 14e, and a solid state drive (SSD, flash memory) 14f. The CPU 14a can perform computation and control of image processing involving an image displayed on the display device 8 and the display device 12, for example. The CPU 14a generates, for example, an overhead image (peripheral image) exhibiting the image of the vehicle 1 at a center from the image data generated by the imagers 15, for example. By displaying a virtual vehicle image of the vehicle 1 on the peripheral image when traveling at a current steering angle, the CPU 14a presents the image in a manner that the driver can intuitively understand a future positional relationship between the vehicle 1 and the object to watch for (such as an obstacle, a parking line, and a section line) located around the vehicle 1. The overhead image can be created by known method, so that description thereof will be omitted. The CPU 14a can perform various kinds of computation and control such as determination on a target moving position (for example, a target parking position) of the vehicle 1, calculation of a guide route for the vehicle 1, determination on interference or non-interference with an object, automatic control (guiding control) of the vehicle 1, and cancellation of automatic control.

The CPU 14a can read an installed and stored computer program from a non-volatile storage device such as the ROM 14b to perform computation in accordance with the computer program. The RAM 14c temporarily stores various kinds of data used in the calculation by the CPU 14a. Of the computation by the ECU 14, the display controller 14d mainly executes synthesis of image data to be displayed on the display device 8. The voice controller 14e mainly executes processing on voice data output from the voice output device 9, of the computation of the ECU 14. The SSD 14f is a rewritable nonvolatile storage and can store therein data upon power-off of the ECU 14. The CPU 14a, the ROM 14b, and the RAM 14c can be integrated in the same package. The ECU 14 may include another logical operation processor such as a digital signal processor (DSP) or a logic circuit, instead of the CPU 14a. The SSD 14f may be replaced by a hard disk drive (HDD). The SSD 14f and the HDD may be provided separately from the ECU 14.

Examples of the brake system 18 include an anti-lock brake system (ABS) for preventing locking-up of the wheels during braking, an electronic stability control (ESC) for preventing the vehicle 1 from skidding during cornering, an electric brake system that enhances braking force (performs braking assistance), and a brake by wire (BBW). The brake system 18 applies braking force to the wheels 3 and the vehicle 1 through an actuator 18a. The brake system 18 is capable of detecting signs of lock-up of the brake and skidding of the wheels 3 from, for example, a difference in the revolving speeds between the right and left wheels 3 for various types of control. Examples of the brake sensor 18b include a sensor for detecting the position of a movable part of the brake 6. The brake sensor 18b can detect the position of a brake pedal being a movable part. The brake sensor 18b includes a displacement sensor. The CPU 14a can calculate a braking distance from a current speed of the vehicle 1 and magnitude of the braking force calculated from a result the detection by the brake sensor 18b.

The steering-angle sensor 19 represents, for example, a sensor for detecting the amount of steering of the steering 4 such as a steering wheel. The steering-angle sensor 19 includes, for example, a Hall element. The ECU 14 acquires the steering amount of the steering 4 operated by the driver and the steering amount of each wheel 3 during automatic steering from the steering-angle sensor 19 for various kinds of control. Specifically, the steering-angle sensor 19 detects the rotation angle of a rotational part of the steering 4. The steering-angle sensor 19 is an exemplary angle sensor.

The accelerator sensor 20 represents, for example, a sensor that detects the position of a movable part of the accelerator 5. The accelerator sensor 20 can detect the position of the accelerator pedal as a movable part. The accelerator sensor 20 includes a displacement sensor.

The shift sensor 21 is, for example, a sensor that detects the position of a movable part of the gearshift 7. The shift sensor 21 can detect positions of a lever, an arm, and, a button as movable parts, for example. The shift sensor 21 may include a displacement sensor or may be configured as a switch.

The wheel-speed sensor 22 represents a sensor for detecting the amount of revolution and the revolving speed per unit time of the wheels 3. The wheel-speed sensor 22 is placed on each wheel 3 to output the number of wheel speed pulses indicating the detected revolving speed, as a sensor value. The wheel-speed sensor 22 may include, for example, a Hall element. The ECU 14 acquires the sensor value from the wheel-speed sensor 22 and computes the moving amount of the vehicle 1 from the sensor value for various kinds of control. In calculating the speed of the vehicle 1 from the sensor value of each wheel-speed sensor 22, the CPU 14a sets the speed of the vehicle 1 according to the speed of the wheel 3 with the smallest sensor value among the four wheels for executing various kinds of control. If one of the four wheels 3 exhibits a larger sensor value than the other wheels 3, such as one wheel 3 exhibiting higher rotation speed per unit period (unit time, or unit distance) by a given value or more than the other wheels 3, the CPU 14a regards the wheel 3 as being slipping (in idling state), and executes various kinds of control. The wheel-speed sensor 22 may be included in the brake system 18 (not illustrated). In such a case, the CPU 14a may acquire a result of the detection of the wheel-speed sensor 22 via the brake system 18.

The configuration, arrangement, and electrical connection of various sensors and actuators described above are merely exemplary, and can be variously set (changed).

By way of example, the ECU 14 implementing the periphery monitoring system 100 generates a peripheral image representing the surroundings of the vehicle 1 in an overhead mode, and causes display of a vehicle image of the vehicle 1 in the overhead mode on the peripheral image, and display of a virtual vehicle image representing a state of the vehicle 4 (a moving position or orientation of the vehicle body) when traveling at the current steering angle.

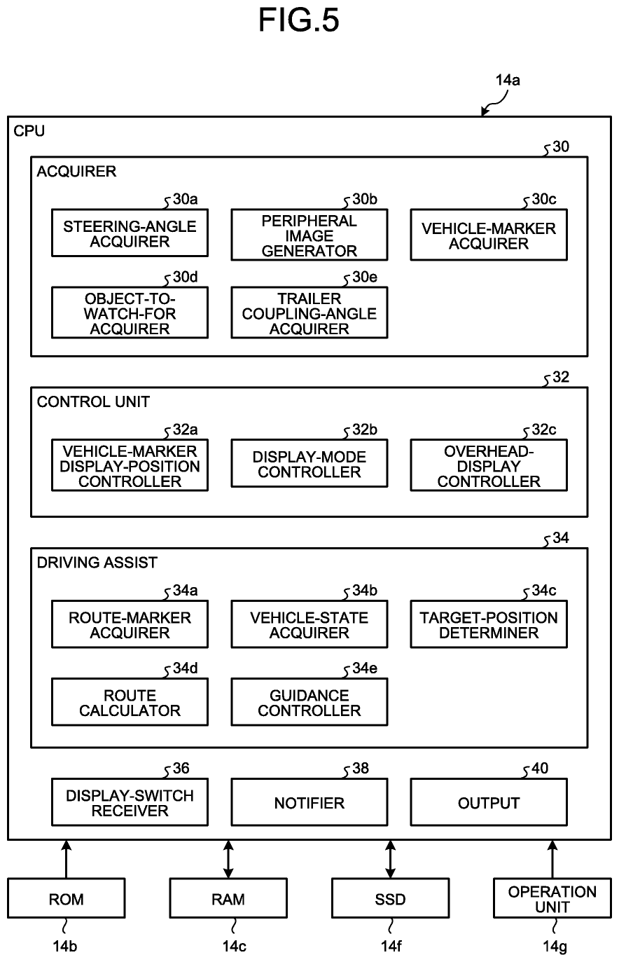

For display in the overhead mode as described above, as illustrated in FIG. 5, the CPU 14a of the ECU 14 includes an acquirer 30, a control unit 32, a driving assist 34, a display-switch receiver 36, a notifier 38, and an output 40. The acquirer 30 includes a steering-angle acquirer 30a, a peripheral-image generator 30b, a vehicle-marker acquirer 30c, an object-to-watch-for acquirer 30d, and a trailer-coupling-angle acquirer 30e. The control unit 32 includes a vehicle-marker display-position controller 32a, a display-mode controller 32b, and an overhead display controller 32c. The driving assist 34 includes a route-marker acquirer 34a, a vehicle-state acquirer 34b, a target-position determiner 34c, a route calculator 34d, and a guidance controller 34e. The CPU 14a can implement these modules by reading and executing installed and stored computer programs from a storage such as the ROM 14b.

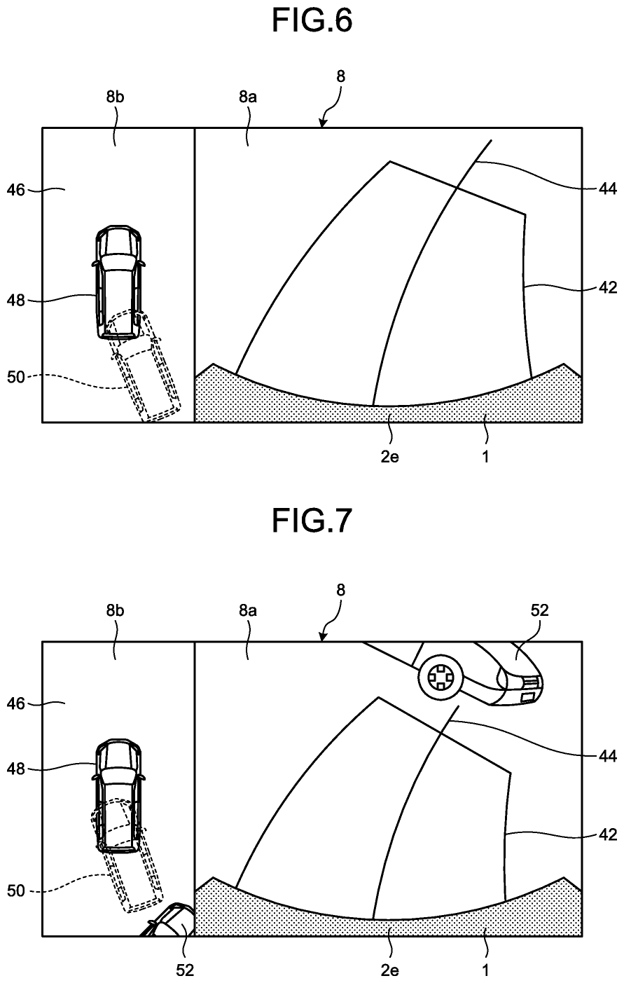

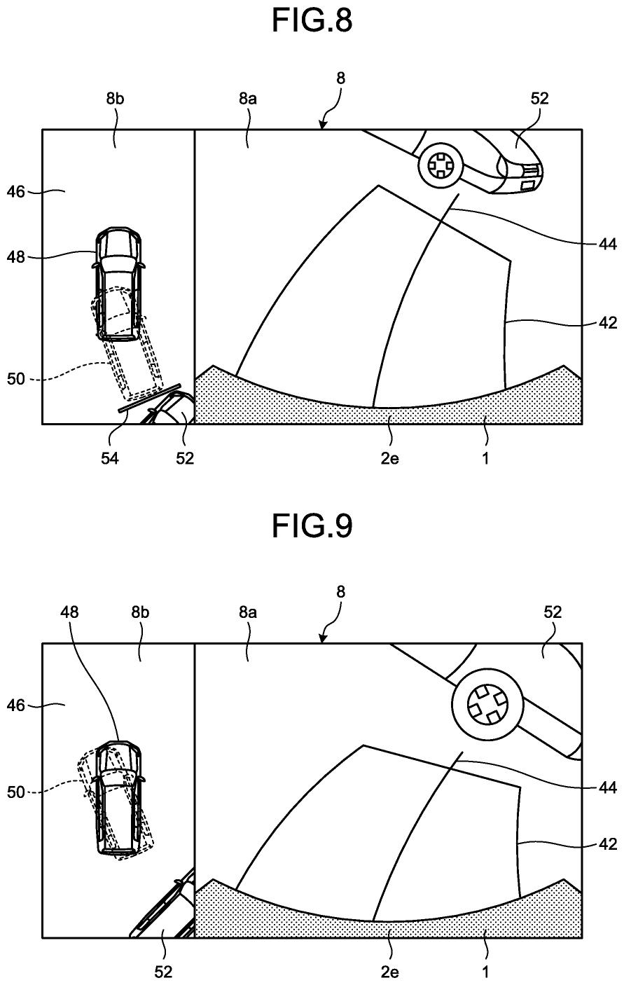

In the present embodiment, the virtual vehicle image may be displayed in a first display mode or a second display mode. FIG. 6 to FIG. 8 depicts examples that a screen 8b displaying in the first display mode is inserted in (superimposed on) the screen 8a of the display device 8. FIG. 6 to FIG. 8 illustrate examples of the vehicle 1 moving backward. For example, as illustrated in FIG. 6, the screen 8a displays an actual image of behind the vehicle based on the image data generated by the imager 15a. The screen 8a displays the rear end 2e of the vehicle 1, and an estimated motion line 42 of the rear wheel 3R (refer to FIG. 2) and an estimated direction line 44 indicating a moving direction of the vehicle 1 when traveling backward at the current steering angle. Display or non-display of the estimated motion line 42 and the estimated direction line 44 may be chosen by the user's (driver's) operation to the operation input 10 and an operation unit 14g. As illustrated in FIG. 6, the screen 8b displays a peripheral image 46 (overhead image) based on the image data generated by the imagers 15, a vehicle image 48 (vehicle icon), and a virtual vehicle image 50 (virtual icon) at a position corresponding to a position of the vehicle 1 traveling backward at the current steering angle by three meters, for example, (traveling backward by a given distance). That is, in this display mode, the virtual vehicle image 50, located behind the vehicle by three meters, moves (rotates) in accordance with the driver's steering, for example. During forward traveling of the vehicle 1 (for example, a gearshift in a forward (D) range), the screen 8a displays an actual image of ahead of the vehicle based on the image data generated by the imager 15c together with the front end 2c of the vehicle 1. The screen 8b displays the virtual vehicle image 50 that moves forward with respect to the vehicle image 48. By way of example, the screen 8a of FIG. 7 and FIG. 8 displays another vehicle 52 (an object to watch for, an obstacle) located adjacent to the vehicle 1. The screen 8b displays another vehicle 52 in the overhead mode at a position corresponding to another vehicle 52 displayed on the screen 8a. By way of example, the screen 8b in FIG. 8 displays an alarm line 54 indicating that another vehicle 52 is approaching and may interfere with (contact with) the virtual vehicle image 50. In the present embodiment, the ranging units 16 and 17 detect another vehicle 52 approaching as described above, but approaching another vehicle 52 can be detected by another method. The alarm line 54 is displayed depending on a result of the detection by the ranging units 16 and 17.

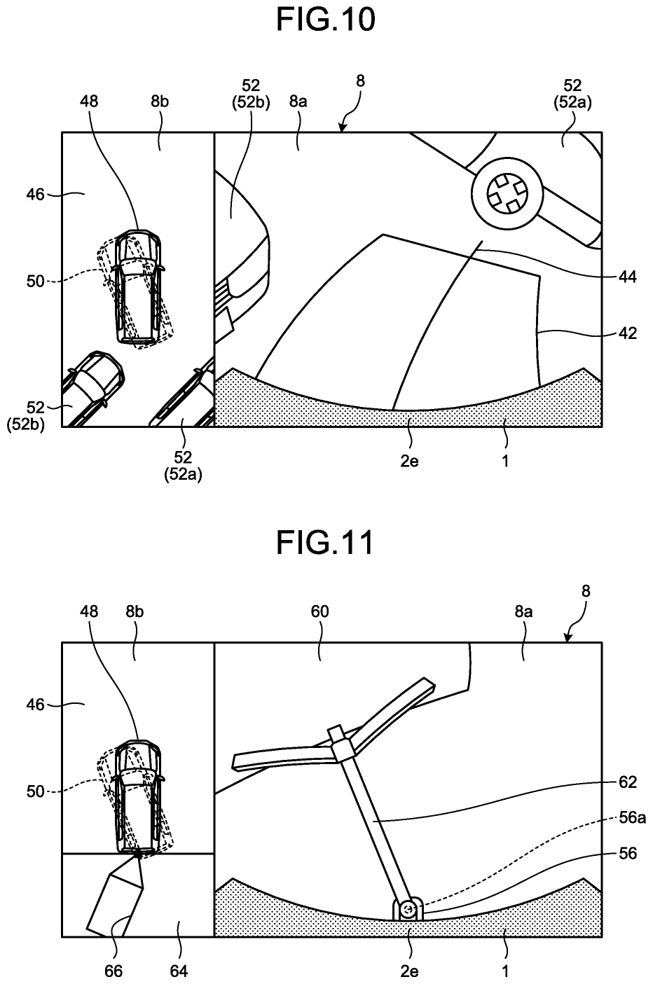

FIG. 9 to FIG. 11 depict examples that the screen 8b displaying the second display mode is inserted in (superimposed on) the screen 8a of the display device 8. FIG. 9 to FIG. 11 are examples of the vehicle 1 moving backward. The screen 8a displays an actual image of behind the vehicle based on the image data generated by the imager 15a. Similar to the first display mode, the screen 8a displays the rear end 2e of the vehicle 1 and the estimated motion line 42 of the rear wheel 3R (refer to FIG. 2) and the estimated direction line 44 indicating the moving direction of the vehicle 1 when traveling backward at the current steering angle. FIG. 9 illustrates an example of displaying another vehicle 52 located in the vicinity of the vehicle 1 on the screen 8a, as in FIG. 7. The screen 8b displays the peripheral image 46, the vehicle image 48 (vehicle icon), and the virtual vehicle image 50 (virtual icon) turned corresponding to a direction of the vehicle 1 traveling backward by three meters at the current steering angle, for example (traveling backward by a given distance). In this case, the virtual vehicle image 50 is at the same position and oriented in a different direction with respect to the vehicle image 48. That is, the virtual vehicle image 50 is in a display mode that it turns about a given rotational center with respect to the vehicle image 48. In this case, the rotational center may be a lengthwise center and a lateral center of the vehicle or a middle point of a rear-wheel shaft of the vehicle in the lengthwise direction. The screen 8b displays the peripheral image 46 including another vehicle 52 appearing on the screen 8a correspondingly. When the vehicle 1 travels forward in the example of FIG. 9, the screen 8a displays an actual image of ahead of the vehicle 1 based on the image data generated by the imager 15c together with the front end 2c of the vehicle 1, as in FIG. 6 described above. The screen 8b displays the virtual vehicle image 50 at the same position as that of the vehicle image 48, turning in a direction corresponding to the orientation of the vehicle 1 moving forward by a given distance, as with the virtual vehicle image 50 traveling backward in FIG. 9. That is, the virtual vehicle image 50 is in a display mode that it turns about a given rotational center with respect to the vehicle image 48. In this case, the rotational center may be the lengthwise center and the horizontal center of the vehicle, or may be the middle point of the rear-wheel shaft of the vehicle. FIG. 10 illustrates the screen 8b in the second display mode in the case of parking the vehicle 1 between two other vehicles 52a and 52b. FIG. 11 illustrates the screen 8b in the second display mode displaying the vehicle 1 including a coupling device 56 (hitch ball 56a) coupled to a towed vehicle 60 via a coupling arm 62, as displayed on the screen 8a. In this case, the screen 8b includes a towed-vehicle display region 64 displaying a towed vehicle image 66 (coupling image) coupled to the vehicle image 48.

To display in the first display mode or the second display mode as described above, the acquirer 30 mainly acquires the peripheral image 46 representing the peripheral situation of the vehicle 1 in the overhead mode based on the image data output from the imagers 15 that images the surroundings of the vehicle 1, and the vehicle image 48 of the vehicle 1 to be displayed on the peripheral image 46 in the overhead mode. That is, the acquirer 30 acquires, from various sensors, the ROM 14b, and the SSD 14f, various kinds of information (data) required for performing display in the overhead mode, and temporarily held it in in the RAM 14c, for example.

For example, the steering-angle acquirer 30a acquires information (a steering angle) on an operation state of the steering 4 (steering wheel) output from the steering angle sensor 19. That is, the steering-angle acquirer 30a acquires a steering angle of a driver's intended traveling direction of the vehicle 1. The steering-angle acquirer 30a may acquire information about whether the vehicle 1 is movable forward or backward, from the position of the movable part of the gearshift 7 acquired from the shift sensor 21, to be able to identify the steering angle as forward steering angle or backward steering angle.

The peripheral-image generator 30b can generate the peripheral image 46 in the overhead mode through known viewpoint conversion and distortion correction on the image data generated by the imagers 15a to 15d. By displaying the peripheral image 46, the peripheral situation of the vehicle 1 can be presented to the user. The peripheral image 46 is based on the image data generated by the imagers 15a to 15d, so that the peripheral image 46 can be an overhead image centered on the vehicle 1 (an image having a viewpoint above the center of the screen 8b) as a basic image. In another embodiment, the viewpoint may be changed through viewpoint conversion to generate the peripheral image 46 representing the position of the vehicle 1 moved to the bottom end, that is, a forward overhead image mainly representing the region ahead of the vehicle 1 in the overhead mode. Conversely, the peripheral image 46 can be an image mainly representing the vehicle 1 moved in position to the top end, that is, a rearward overhead image of the region behind the vehicle 1 in the overhead mode. For example, the forward overhead image is useful for the first display mode, with no object to watch for located and the virtual vehicle image 50 largely moving ahead of the vehicle 1. The rearward overhead image is useful for the first display mode with the virtual vehicle image 50 largely moving behind the vehicle 1. The overhead image including the vehicle 1 (vehicle image 48) at the center is useful for the second display mode. The present embodiment describes an example of displaying the vehicle image 48 at a center of the peripheral image 46, but the display position of the vehicle image 48 can be appropriately changed by the user's (driver's) operation to the operation input 10.

The vehicle-marker acquirer 30c acquires, as vehicle markers, the vehicle image 48 (vehicle icon) of the vehicle 1 in the overhead mode, the virtual vehicle image 50 (virtual icon), and the towed vehicle image 66 of the towed vehicle 60 (a trailer icon, refer to FIG. 11) from the ROM 14b or the SSD 14f. The vehicle image 48 and the virtual vehicle image 50 preferably have a shape corresponding to an actual shape of the vehicle 1. By the display of the vehicle image 48 and the virtual vehicle image 50 in the shape corresponding to the actual shape of the vehicle 1, an object based on the image data is displayed on the peripheral image 46 more accurately in terms of distance to another vehicle 52 or a wall and the relationship between the vehicle 1 and another vehicle 52 or a wall, for example, and it can be more recognizable to the driver. The vehicle image 48 and the virtual vehicle image 50 can be the same data displayed in different display modes as long as they are distinguishable from each other. For example, the vehicle-marker display-position controller 32a of the control unit 32 may set higher transmittance to the virtual vehicle image 50 on display than the vehicle image 48 to make the virtual vehicle image 50 and the vehicle image 48 more distinguishable. The virtual vehicle image 50 and the vehicle image 48 may be displayed in different colors or with or without blinking for distinguishable display. The towed vehicle 60 (refer to FIG. 11) of various lengths and shapes can be coupled to the vehicle 1. Thus, the towed vehicle image 66 may be set to a shape of a representative towed vehicle 60, or it may be an icon simply indicated by lines as illustrated in FIG. 11.

The object-to-watch-for acquirer 30d acquires an object to watch for of the vehicle 1 when traveling, from the result of the detection by the ranging units 16 and 17 and the image data generated by the imagers 15, for example. For example, the ranging units 16 and 17 searches the surroundings of the vehicle 1 for an object such as another vehicle 52, a bicycle, a pedestrian, a wall, a structure, and if found, the object-to-watch-for acquirer 30d acquires (detects) a distance (positional information) to the object. The object-to-watch-for acquirer 30d detects a parking line indicating a parking region, a section line, and a stop line drawn on the road surface through image processing on the image data generated by the imagers 15. The object detected by the ranging units 16 and 17 can be used for the vehicle-marker display-position controller 32a of the control unit 32 to stop moving (first display mode) or turning (second display mode) of the virtual vehicle image 50, to determine whether the virtual vehicle image 50, when displayed, interferes (contacts) with the object, that is, whether the vehicle 1 can continue to travel at the current steering angle, and to notify the user (driver) of presence of the object to call for attention. The parking line, the section line, and the stop line detected based on the image data generated by the imagers 15 can be used in notifying the user of drive timing or an amount of driving the vehicle 1 for guiding the vehicle 1 to the location thereof. The object to watch for can be detected with a laser scanner, for example. The imagers 15 may be stereo cameras to detect presence of the object or a distance to the object detected from the image data. In this case, the ranging units 16 and 17 are omissible.

In the case of the vehicle 1 coupled with the towed vehicle 60 (trailer), the trailer-coupling-angle acquirer 30e detects a coupling angle between the vehicle 1 and the towed vehicle 60 (an angle and a coupling state of the coupling arm 62 with respect to the vehicle 1) from the image data generated by the imager 15a, for example. While the vehicle 1 coupled with the towed vehicle 60 is traveling, the vehicle 1 and the towed vehicle 60 may differently behave from each other. Specifically, while the vehicle 1 travels backward, the coupling angle between the vehicle 1 and the towed vehicle 60 may increase or decrease depending on the steering angle of the vehicle 1 and a current coupling angle. Thus, the vehicle-marker display-position controller 32a of the control unit 32 moves the virtual vehicle image 50 in accordance with the acquired coupling angle while displaying the vehicle image 48 and the towed vehicle image 66, to facilitate estimation of future behavior of the towed vehicle 60 (towed vehicle image 66). In the case of the coupling device 56 (hitch ball 56a) coupling the vehicle 1 to the towed vehicle 60 including an angle sensor, the coupling angle of the coupling arm 62 may be directly acquired from the angle sensor. This reduces the processing load of the CPU 14a from that by image processing on the image data. Without the coupling device 56 of the vehicle 1 for coupling to the towed vehicle 60, the trailer-coupling-angle acquirer 30e may be omissible.

The control unit 32 mainly performs control of the display of, on the peripheral image 46, the virtual vehicle image 50 representing a state of the vehicle 1 traveling at the current steering angle in the overhead mode together with the vehicle image 48.

The vehicle-marker display-position controller 32a determines a display position of the vehicle image 48 being one of the vehicle markers acquired by the vehicle-marker acquirer 30c. As described above, the vehicle-marker display-position controller 32a may choose a viewpoint of the peripheral image 46 (overhead image) in accordance with a moving direction of the virtual vehicle image 50, to determine the display position of the vehicle image 48 in accordance with the viewpoint. The vehicle-marker display-position controller 32a determines a display position of the virtual vehicle image 50 being one of the vehicle markers in accordance with the steering angle of the vehicle 1 acquired by the steering-angle acquirer 30a. In the first display mode of the virtual vehicle image 50, the vehicle-marker display-position controller 32a displays the virtual vehicle image 50 on the peripheral image 46 (overhead image) such that it continuously or intermittently moves to a position corresponding to a position of the vehicle 1 traveling by three meters at a steering angle at that point, with reference to the display position of the vehicle image 48, for example. In this case, as illustrated in FIG. 6 and FIG. 7, the virtual vehicle image 50 moves on the peripheral image 46 along the actual moving route of the vehicle 1. Thus, the positional relationship between the vehicle 1 and an object located around the vehicle 1 can be recognizably displayed in an overhead view via the virtual vehicle image 50. Specifically, with another vehicle 52 located around the vehicle 1, the user can check through the overhead image with what distance the vehicle 1 approaches another vehicle 52 and whether the vehicle 1 can pass by another vehicle 52. This enables the user to intuitively recognize the positional relationship between the vehicle 1 and another vehicle 52 from present to future.

In the first display mode of the virtual vehicle image 50, after the object-to-watch-for acquirer 30d detects the object to watch for, the vehicle-marker display-position controller 32a can acquire a display stop position to stop the virtual vehicle image 50 before the virtual vehicle image 50 comes into contact with another vehicle 52, for example. That is, in displaying the virtual vehicle image 50 running away from the vehicle image 48, the virtual vehicle image 50 can be stopped before contacting another vehicle 52 for the purpose of calling for the driver's attention. That is, the display can show that the vehicle 1 can travel until the stop position of the virtual vehicle image 50 without contacting with the obstacle such as another vehicle 52.

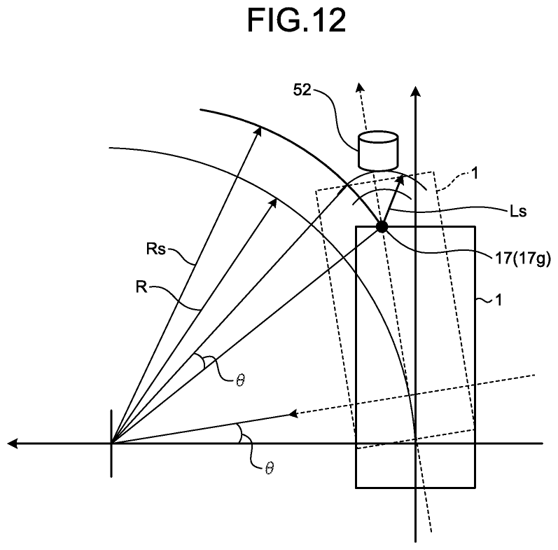

FIG. 12 illustrates timing at which the vehicle 1, when turning at the current steering angle (by a turning radius R around the rear-wheel shaft), comes into contact with another vehicle 52. FIG. 12 illustrates an example that the ranging unit 17g mounted on the front end of the vehicle 1 detects another vehicle 52. For example, a turning radius of the ranging unit 17g when the vehicle 1 turns at the current steering angle is defined to be Rs, and a distance to another vehicle 52 detected by the ranging unit 17g is defined to be Ls. The relation, 2π:θ=Rs: Ls is established where θ represents a deflection angle of the vehicle 1, traveling (turning) at the current steering angle and coming into contact with another vehicle 52 (a turning angle around the rear-wheel shaft is θ). That is, θ=2π*Ls/Rs holds. Thus, by acquiring the display stop position where the virtual vehicle image 50 is displayed before the position of the vehicle image 48 turned from the display position by the deflection angle θ, the vehicle-marker display-position controller 32a can display the stop of the virtual vehicle image 50 before contacting with another vehicle 52 as illustrated in FIG. 7. As illustrated in FIG. 8, the alarm line 54 can be displayed at a position turned from the rear end of the vehicle image 48 by the deflection angle θ. As advance notification, another vehicle 52 and the virtual vehicle image 50 in contact with each other may be displayed.

In the second display mode of the virtual vehicle image 50, the vehicle-marker display-position controller 32a displays the virtual vehicle image 50 on the peripheral image 46 (overhead image) such that at the display position, the vehicle image 48 is oriented in a direction corresponding to the orientation of the vehicle 1 traveling, for example, by three meters at the current steering angle. In this case, as illustrated in FIG. 9 and FIG. 10, for example, only the vehicle body on the virtual vehicle image 50 is changed in direction around the position corresponding to the center of the rear shaft in the current position of the vehicle 1 (vehicle image 48). This enables recognizable display of the vehicle 1 in an overhead view via the virtual vehicle image 50, i.e., in what orientation the vehicle 1 approaches an object located around the vehicle. Specifically, with another vehicle 52 located around the vehicle 1, the user can check the angle of the vehicle 1 approaching another vehicle 52 through the overhead image, and the user's intuitive recognition can improve.

In the case of the towed vehicle 60 coupled to the vehicle 1, the vehicle-marker display-position controller 32a displays the towed vehicle image 66 acquired by the vehicle-marker acquirer 30c on the peripheral image 46 (overhead image) in accordance with the coupling angle acquired by the trailer-coupling-angle acquirer 30e. For example, as illustrated in FIG. 11, in the second display mode of the virtual vehicle image 50, a future turning direction of the vehicle image 48 is exhibited by the virtual vehicle image 50 in an overhead view, which makes it possible for the user to intuitively understand a future turning (rotating) direction of the towed vehicle image 66.

The display-mode controller 32b mainly changes the display mode of the virtual vehicle image 50. For example, as illustrated in FIG. 6, with no object to watch for located around the vehicle image 48, that is, with no vehicle 52 located around the vehicle 1, for example, the vehicle 1 has no trouble in continue running at the current steering angle. As illustrated in FIG. 7, with presence of the object to watch for around the vehicle image 48, that is, with another vehicle 52 located around the vehicle 1, for example, the vehicle 1 may come into contact with another vehicle 52 if continuously running at the current steering angle. In such a case, when the distance between the virtual vehicle image 50 and another vehicle 52 reaches a given distance, the display-mode controller 32b changes a display color of the virtual vehicle image 50 from green in regular setting to highlighted red, for example, to call for the user's attention.

For another example, the virtual vehicle image 50 may be changed from non-blinking in regular setting to blinking to call the user's attention. As illustrated in FIG. 8, the display-mode controller 32b can also display the alarm line 54 indicating that another vehicle 52 is approaching and may interfere (contact) with the virtual vehicle image 50. The alarm line 54 may be displayed on the peripheral image 46 when another vehicle 52 is detected by the object-to-watch-for acquirer 30d and displayed on the peripheral image 46, or when the virtual vehicle image 50 approaches another vehicle 52. For example, the alarm line 54 may be displayed as an advance notice prior to the timing when the virtual vehicle image 50 is changed in color to red. In this case, stepwise warning to the user is feasible, which can more easily call for attention of the user.

In the second display mode illustrated in FIG. 9 and FIG. 10, with an obstacle such as another vehicle 52 located in a turning direction of the virtual vehicle image 50, the display-mode controller 32b changes the display color of the virtual vehicle image 50 from green in regular setting to highlighted red, for example, to call attention of the user. In this case, the driver can change the turning direction of the virtual vehicle image 50 by steering the vehicle 1 while stopping, and can determine the steering angle at which the vehicle 1 can approach another vehicle 52 without contact therewith, while viewing the display color of the virtual vehicle image 50. Specifically, as illustrated in FIG. 10, in the case of parking the vehicle 1 between the two other vehicles 52a and 52b, the display-mode controller 32b changes the display color of the virtual vehicle image 50 from green in regular setting to highlighted red, if the virtual vehicle image 50 displayed in the second display mode is oriented in a direction that the vehicle 1 may contact another vehicle 52a or another vehicle 52b. In this case, by steering leftward and rightward while the vehicle 1 is at a stop to change the turning direction of the overhead virtual vehicle image 50, the driver can find a steering angle at which the vehicle 1 comes into contact or no contact with another vehicle 52a or another vehicle 52b. As a result, the driver can find the steering angle so as to turn the display color to green of regular setting, for example, and smoothly move the vehicle 1 backward with no contact with another vehicle 52a or another vehicle 52b.

The overhead display controller 32c controls the display mode of the screen 8b. For example, the peripheral image 46 as an overhead image may be displayed in response to a user's (driver's) request through the operation input 10. The peripheral image 46 may be displayed, assuming issuance of a display request, if the driver operates to transition to backward traveling, increasing blind spots, or upon detection of the object (obstacle) to watch for by the object-to-watch-for acquirer 30d in the traveling direction. After acquiring a display request for the peripheral image 46, the overhead display controller 32c switches the screen 8a of the display device 8 displaying a navigation screen or an audio screen in regular setting to an actual-image display mode representing the traveling direction of the vehicle 1, and displays the screen 8b together with the screen 8a. As illustrated in FIG. 11, after acquiring a display request for the peripheral image 46 while the vehicle 1 is coupled to the towed vehicle 60, the overhead display controller 32c forms the towed-vehicle display region 64 in the peripheral image 46. In FIG. 6 to FIG. 11, the screen 8b of the display device 8 is relatively smaller in size than the screen 8a. However, the overhead display controller 32c may change the display region of the screen 8b to larger than the screen 8a in response to the user's operation to the operation input 10, for example. Thus, the overhead image is enlargeable on display, which enables the user to easily recognize the behavior of the virtual vehicle image 50 and the positional relationship between the virtual vehicle image 50 and another vehicle 52, for example. The overhead display controller 32c may also display the screen 8b on the display device 8 entirely. In another embodiment, the displayed items may be displayed on the display device 12 in place of the screen 8b. In this case, the user can easily check the details of the overhead image while minimally moving the line of vision. The overhead display controller 32c may start the display, regarding the traveling start of the vehicle 1 during the display of the peripheral image 46 as receipt of a display request for the virtual vehicle image 50, for example. In this case, for example, the virtual vehicle image 50 is prevented from being continuously displayed during stop of the vehicle 1, which can simplify the display elements of the peripheral image 46. As a result, the driver can easily check the peripheral situation of the vehicle 1 in an overhead view. In displaying the virtual vehicle image 50, the driver may start display of the virtual vehicle image 50 while gradually moving (moving backward or forward) the vehicle 1, to display a future relationship between the vehicle 1 and the surroundings. In this case, the driver can understand a future moving route while gradually moving the vehicle 1, to be able to choose an appropriate moving route to deal with the most recent peripheral situation.

The driving assist 34 acquires the estimated motion line 42 and the estimated direction line 44 to be displayed on the screen 8a, provides assistance for the driver to drive the vehicle 1, and parking assistance to drive the vehicle 1 to enter a parking region, and exit assistance for exiting the vehicle 1 from the parking region.

The route-marker acquirer 34a acquires the estimated motion line 42 and the estimated direction line 44 according to the steering angle of the vehicle 1 acquired by the steering-angle acquirer 30a, and a position of the gearshift 7 (shift lever), or receipt of a forward instruction or a backward instruction from the driver through the operation input 10. The estimated motion line 42 and the estimated direction line 44 are displayed ahead of or behind the vehicle 1 up to three meters, for example. A display length may be changed by the driver's operating the operation input 10. The estimated motion line 42 can indicate a future position of the wheel 3 on a road surface when the vehicle 1 travels at the current steering angle. The estimated motion line 42 is changed depending on the steering angle of the vehicle 1, so that the driver can easily search for a route by which the vehicle 1 can run on a road surface having less unevenness, for example. Similarly, the estimated direction line 44 can indicate a future moving direction of the vehicle 1 when traveling at the current steering angle. The estimated direction line 44 is also changed depending on the steering angle of the vehicle 1, so that the driver can easily find a moving direction of the vehicle 1 while comparing with the peripheral situation of the vehicle 1, by changing a steering amount.

The vehicle-state acquirer 34b acquires a current status of the vehicle 1 to perform driver assistance for the vehicle 1. For example, the vehicle-state acquirer 34b acquires magnitude of current braking force from a signal from the brake system 18, or acquires a current vehicle speed or a degree of acceleration/deceleration of the vehicle 1 from a result of the detection from the wheel-speed sensor 22. In accordance with a signal from the gearshift 7, the vehicle-state acquirer 34b also acquires the current state of the vehicle 1 such as being movable forward or backward, or stoppable (parkable).

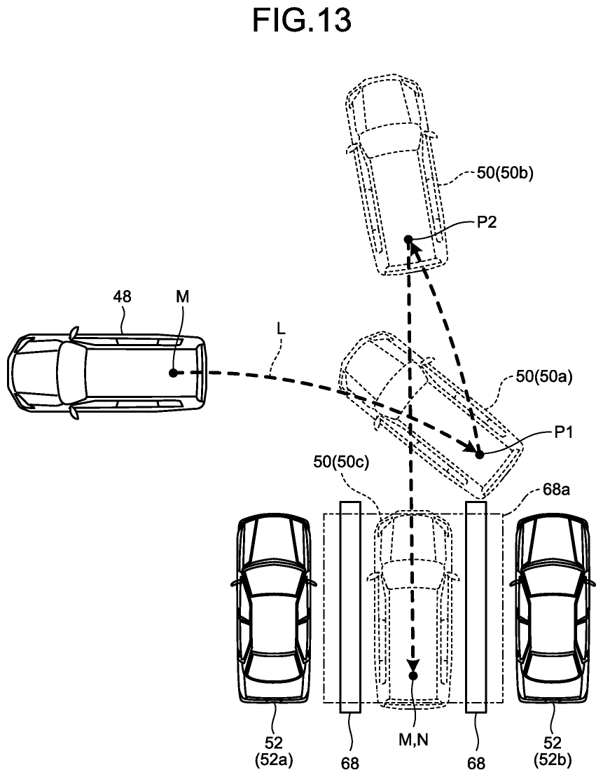

The target-position determiner 34c, the route calculator 34d, and the guidance controller 34e mainly function to provide parking assistance or exit assistance. FIG. 13 illustrates an exemplary display of the virtual vehicle image 50 when the periphery monitoring system 100 operates in a parking assistance mode, for example. FIG. 13 is an enlarged view of the peripheral image 46 displayed on the screen 8b. In this case, the vehicle image 48 contains a large amount of information, therefore, the screen 8b may be displayed entirely on the display device 8. Examples of the parking assistance include an automatic assistance mode, a semiautomatic assistance mode, and a manual assistance mode. The automatic assistance mode is for the ECU 14's automatic operations (steering operation, access operation, brake operation) other than shifting of the gearshift 7 (switching between forward movement and backward movement). The semiautomatic assistance mode is for partial automatic operation. The manual assistance mode is for the driver to steer, access, and brake through route guidance or operation guidance alone.

In the present embodiment, in the first display mode, the virtual vehicle image 50 is moved in advance prior to the vehicle image 48 on the overhead peripheral image 46, to display progress of guidance in one of the assistance modes. In actually guiding the vehicle 1, the vehicle 1 may be directly guided to the target parking position from a guidance start position without turning back, and the vehicle 1 may turn back two or more times or temporarily stop. FIG. 13 illustrates an example that the vehicle turns back, and the display mode of the virtual vehicle image 50 is changed at a turn-back point (point to watch for). In this case, the overhead virtual vehicle image 50 moves ahead on a guide route, which makes it easier for the driver to know the positional relationship between the vehicle 1 and a peripheral obstacle (such as another vehicle 52) in advance, and to be given a sense of safety. The virtual vehicle image 50 moving ahead can clearly exhibit the point to watch for, which can enhance the driver's sense of safety in the semiautomatic assistance mode or the manual assistance mode. At the point to watch for, the virtual vehicle image 50 is stopped with reference to the display stop position acquired by the vehicle-marker display-position controller 32a, or the display-mode controller 32b changes the display mode of the virtual vehicle image 50 from green in general color setting to red as an attention color, for example. In the first display mode, the virtual vehicle image 50 is stopped at the point to watch for on display, the ECU 14 causes the vehicle 1 to move to a position corresponding to the point to watch for. After completion of temporary stop or gear-shifting, the control unit 32 separates the virtual vehicle image 50 from the vehicle image 48 again to the next point to watch for on display. By repeating this operation, the vehicle image 48 (vehicle 1) is guided to the target parking position.

In actual parking assistance for the vehicle 1, a reference point set to the vehicle 1 is guided to the target parking position within a parkable region to place the vehicle 1 in the parkable region. The reference point is set at the center of the rear-wheel shaft, for example. Thus, to guide the vehicle image 48 on the screen 8b, as illustrated in FIG. 13, a reference point M of the vehicle image 48 (for example, a center of the rear-wheel shaft) corresponding to the reference point of the vehicle 1 is moved along a guide route L. In a parking framed with section lines 68, the vehicle image 48 is then moved to a target parking position N that is set in a space (parkable region) between another vehicle 52a and another vehicle 52b. In FIG. 13, when the virtual vehicle image 50 (50a) moves away from the display position of the vehicle image 48 to a turn-back point P1, the vehicle-marker display-position controller 32a stops moving the virtual vehicle image 50 (50a), and the display-mode controller 32b changes the display color of the virtual vehicle image 50 (50a) to highlighted red, for example, to notify the driver of temporary stop at the present position and shift the gear from a backward range to a forward range. In this case, the virtual vehicle image 50 (50a) is stopped and displayed in red until the vehicle 1 (vehicle image 48) actually reaches the turn-back point P1. When the vehicle 1 (vehicle image 48) actually reaches the turn-back point P1 and the gear is shifted to the forward range, the control unit 32 switches the display mode of the virtual vehicle image 50 (50b) to green as regular color and moves it toward the next turn-back point P2. The virtual vehicle image 50 (50b) stops at the turn-back point P2, and the control unit 32 changes the display color of the virtual vehicle image 50 (50b) to red again, for example, to notify the driver of temporary stop at the present position and gear-shifting from the forward range to the backward range. When the vehicle 1 (vehicle image 48) reaches the turn-back point P2 and the gear is shifted to the backward range, the control unit 32 switches the display mode of the virtual vehicle image 50 (50c) to green as regular color and moves it toward the next target parking position N. The virtual vehicle image 50 (50c) stops at the target parking position N, and the control unit 32 notifies the driver again of the stop at the present position (reaching the target parking position N) by blinking of the virtual vehicle image 50 (50c) maintained in green, for example. When the vehicle 1 (vehicle image 48) actually reaches the target parking position N, the parking assistance ends.

The same applies to the exit assistance. For example, to notify the driver of a temporarily stop at the time when the front part of the vehicle 1 exits from the parking space to a road, the display color of the virtual vehicle image 50, which is away from the vehicle image 48 in a parked state on the peripheral image 46, is changed to red, for example, at the time when the virtual vehicle image 50 reaches the road. In this case, the driver can check rightward and leftward to enter the road. Also in this case, the driver can understand the peripheral situation from the virtual vehicle image 50 displayed in the overhead mode, and easily recognize a temporary stop location to check rightward and leftward.

To perform such parking assistance (exit assistance), the target-position determiner 34c detects a parkable region 68a in the peripheral region of the vehicle 1 with reference to an obstacle around the vehicle 1 and a parking line or a stop line on the road surface, which are acquired by the object-to-watch-for acquirer 30d based on the information from the imagers 15 and the ranging units 16 and 17. The target-position determiner 34c also determines the target parking position N for guiding the vehicle 1 with reference to the detected parkable region 68a and the information from the imagers 15 and the ranging units 16 and 17.

The route calculator 34d calculates the guide route L for guiding the vehicle 1 from the present position of the vehicle 1 to the target parking position (such that the reference point M matches with the target parking position N) by a known method. In response to receipt of request for the point to watch for (turn-back point), the route calculator 34d sets the point to watch for (turn-back point) on the guide route with reference to the obstacle located around the vehicle 1 (such as the other vehicles 52a and 52b) and the section line 68 acquired by the object-to-watch-for acquirer 30d.

The guidance controller 34e guides the vehicle 1 along the guide route L calculated by the route calculator 34d. In this case, when the turn-back point P1 is set on the guide route L, for example, a voice message may be output via the voice controller 14e, or a text message or an indicator may be displayed on the display device 8 or the display device 12 to prompt the driver to temporarily stop the vehicle 1 and shift the gear at the present position.

The display-switch receiver 36 receives an operation signal (request signal) when the driver makes a display request for the virtual vehicle image 50 in the overhead mode via the operation input 10 or the operation unit 14g. In another embodiment, for example, the display-switch receiver 36 may regard the shifting of the gearshift (shift lever) to the backward range as the display request for the virtual vehicle image 50 in the overhead mode, and receive the request signal. The display-switch receiver 36 may also receive a cancel request for canceling display of the virtual vehicle image 50 in the overhead mode via the operation input 10 or the operation unit 14g.

With reference to the obstacle (such as another vehicle 52) located around the vehicle 1 and the section line 68, acquired by the object-to-watch-for acquirer 30d, the notifier 38 displays a message on the screen 8a, or outputs a voice message via the voice controller 14e if the object to watch for is present around the vehicle 1. The notifier 38 may allow the display-mode controller 32b to change the display mode of the vehicle image 48 or the virtual vehicle image 50 on the peripheral image 46 for a necessary notification. The output 40 outputs, to the display controller 14d or the voice controller 14e, overhead display determined by the control unit 32 or the details of assistance determined by the driving assist 34.

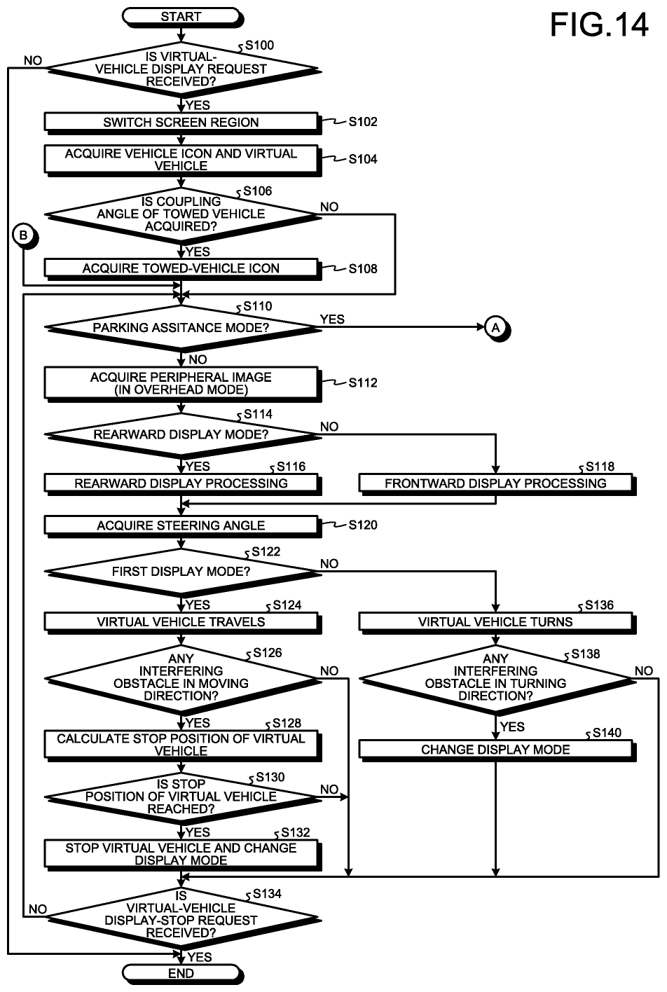

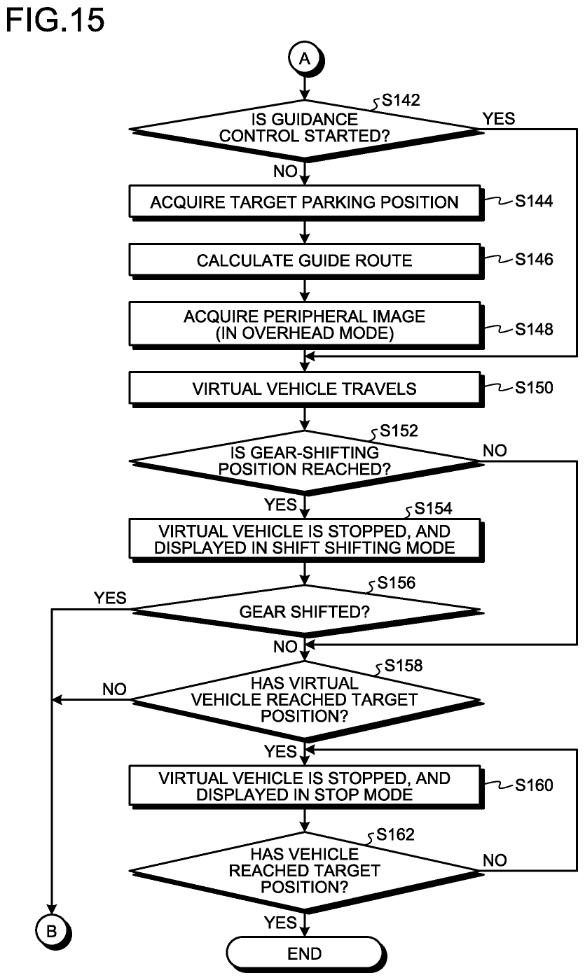

The following describes an example of display processing to the overhead image performed by the periphery monitoring system 100 configured as described above with reference to the flowcharts in FIG. 14 and FIG. 15. In the following example, the display device 8 displays a navigation screen or an audio screen, or the screen 8a displaying a region ahead of the vehicle 1 in regular setting as a whole.

First, the ECU 14 checks whether the display-switch receiver 36 receives the display request for the virtual vehicle image 50 (S100). With no display request for the virtual vehicle image 50 received (No at S100), it temporarily ends this processing. After receiving the display request for the virtual vehicle image 50 (Yes at S100), the overhead display controller 32c switches the screen 8a of the display device 8 (S102). That is, the regular mode of the screen 8a displaying a navigation screen or an audio screen is switched to a mode of displaying an actual image representing the traveling direction of the vehicle 1. As illustrated in FIG. 6, for example, the screen 8b displaying the peripheral image 46 is displayed together with the screen 8a.

Subsequently, the vehicle-marker acquirer 30c acquires, from a storage such as the ROM 14b, the vehicle image 48 (vehicle icon) and the virtual vehicle image 50 (virtual vehicle, virtual icon) in the overhead mode (S104). In this case, the acquired output 40 and virtual vehicle image 50 may be the same data in different display modes. At this point, if the trailer-coupling-angle acquirer 30e acquires the coupling angle of the towed vehicle 60 (Yes at S106), the vehicle-marker acquirer 30c acquires the towed vehicle image 66 (towed vehicle icon) (S108). If the trailer-coupling-angle acquirer 30e does not acquire the coupling angle of the towed vehicle 60 (No at S106), that is, if the vehicle 1 does not tow the towed vehicle 60, the processing skips S108. If the vehicle 1 tows the towed vehicle 60 and cannot acquire the coupling angle from the image data generated by the imager 15a due to dark environment, for example, the processing skips S108.

If currently controlling in a mode other than the parking assistance mode (No at S110), for example, the ECU 14 acquires the peripheral image 46 (overhead image) generated by the peripheral-image generator 30b to be displayed on the screen 8b (S112). Subsequently, the ECU 14 checks whether a rearward display mode is currently requested from an operation state of the gearshift 7 or the operation input 10 (S114). In the rearward display mode (Yes at S114), for example, when the gearshift 7 is shifted to the backward range, or when acquiring a signal indicating that the driver intends to perform backward travel through an input to the operation input 10, the ECU 14 performs rearward display processing for displaying an image of behind the vehicle as succeeding processing (S116). That is, the screen 8a displays an actual image of a region behind the vehicle 1 imaged by the imager 15a, and the screen 8b displays the virtual vehicle image 50 moving backward. If the rearward display mode is not requested at S114 (No at S114), for example, when the gearshift 7 is shifted to the forward range, or when acquiring a signal indicating that the driver intends to drive the vehicle forward through an input to the operation input 10, the ECU 14 performs frontward display processing for displaying an image of ahead of the vehicle as succeeding processing (S118). That is, the screen 8a displays an actual image of the region ahead of the vehicle 1 imaged by the imager 15c, and the screen 8b displays the virtual vehicle image 50 moving forward.

Subsequently, the ECU 14 acquires the steering angle of the vehicle 1 detected by the steering angle sensor 19 via the steering-angle acquirer 30a (S120). If the display request for the virtual vehicle is received at S100, and the received request is the first display mode (Yes at S122), the vehicle-marker display-position controller 32a displays the virtual vehicle image 50 traveling away from the vehicle image 48 in a direction corresponding to the steering angle of the vehicle 1 (S124). In this case, the virtual vehicle image 50 may be continuously or intermittently displayed. This display mode may be chosen by the driver. The route-marker acquirer 34a acquires the estimated motion line 42 and the estimated direction line 44 in accordance with the steering angle of the vehicle 1 and superimpose them on the actual image on the screen 8a.

At this point, after determining that the object to watch for (for example, another vehicle 52) acquired by the object-to-watch-for acquirer 30d is present in the moving direction of the virtual vehicle image 50, and the object is an obstacle that may interfere with (come into contact with) the vehicle (Yes at S126), the vehicle-marker display-position controller 32a calculates a stop display position of the virtual vehicle image 50 (S128). If the display position of the virtual vehicle image 50 reaches the calculated stop display position (Yes at S130), for example, the vehicle-marker display-position controller 32a stops moving display of the virtual vehicle image 50 immediately before another vehicle 52 (at the stop display position) as illustrated in FIG. 7. The display-mode controller 32b changes the display mode of the virtual vehicle image 50 to a highlighted display (S132). For example, the display color of the virtual vehicle image 50 is changed from green in regular setting to red for calling attention. The display-mode controller 32b may also change the state of the virtual vehicle image 50 from a non-blinking state in regular setting to a blinking state for calling attention. If the display position of the virtual vehicle image 50 does not reach the calculated stop display position (No at S130), the vehicle-marker display-position controller 32a skips the processing at S132. That is, for example, as illustrated in FIG. 6, the virtual vehicle image 50 continuously moves by a given distance (for example, to a position in a three-meter distance) behind the vehicle image 48 on display with no change in the display mode of the virtual vehicle image 50. If the object-to-watch-for acquirer 30d does not detect the object to watch for at S126, or if determining that the object to watch for is detected but not in the moving direction of the virtual vehicle image 50 (No at S126), the processing skips S128 to S132. That is, as illustrated in FIG. 6, the virtual vehicle image 50 continuously moves by a given distance (for example, to a position at a distance of three meters) behind the vehicle image 48 on display, with no change in the display mode of the virtual vehicle image 50.

Subsequently, the ECU 14 monitors receipt or no receipt of a display stop request for the virtual vehicle image 50 via the display-switch receiver 36 (S134). With no receipt of the display stop request (No at S134), the ECU 14 returns to S110, to continuously display the virtual vehicle image 50. For example, if the mode is not changed at S110 and S122, the virtual vehicle image 50 temporarily disappears from the peripheral image 46, and is displayed again away from the position of the vehicle image 48 and moves in a direction corresponding to the current steering angle of the vehicle 1. Thus, in response to the change in the steering angle of the vehicle 1, the virtual vehicle image 50 moves on the display in a direction different from that in previous display. That is, the virtual vehicle image 50 can be moved in a direction for avoiding the obstacle such as another vehicle 52. Thus, it is possible to find the steering angle of the vehicle 1 not to interfere with (come into no contact with) another vehicle 52 while referring to movement of the virtual vehicle image 50.

After receipt of the display request for a mode other than the first display mode at S122 (No at S122), that is, the display request for the second display mode, the vehicle-marker display-position controller 32a displays the virtual vehicle image 50 acquired at S104 at the display position of the vehicle image 48 to turn in a direction corresponding to the vehicle body direction at the time when the vehicle 1 moves backward by a given distance (for example, three meters) at the current steering angle (S136). At this point, the route-marker acquirer 34a acquires the estimated motion line 42 and the estimated direction line 44 in accordance with the steering angle of the vehicle 1 to be superimposed on the actual image on the screen 8a.

If determining that the object to watch for (for example, another vehicle 52) is present in the turning direction of the virtual vehicle image 50 determined by the vehicle-marker display-position controller 32a as an obstacle interfering with the vehicle (Yes at S138), the display-mode controller 32b changes the display mode of the virtual vehicle image 50 to a highlighted display (S140), and advances the process to S134. For example, as illustrated in FIG. 9 and FIG. 10, while another vehicle 52 is located in the orientation of the virtual vehicle image 50, the display color of the virtual vehicle image 50 is changed from green in regular setting to red for calling attention. The display-mode controller 32b may change the state of the virtual vehicle image 50 from the non-blinking state in regular setting to the blinking state for calling attention. If determining that the object to watch for (for example, an obstacle) is not present in the turning direction of the virtual vehicle image 50 (No at S138), the processing proceeds to S134, skipping S140.

After acquiring the coupling angle of the towed vehicle 60 at S106 and the towed vehicle image 66 at S108, the overhead display controller 32c displays the towed-vehicle display region 64 on the screen 8b as illustrated in FIG. 11. The overhead display controller 32c then displays the towed vehicle image 66 coupled to the vehicle image 48 in accordance with a current coupling angle of the towed vehicle 60. In this case, the virtual vehicle image 50 and the towed vehicle image 66 are displayed in the overhead mode. As a result, in the first display mode or the second display mode of the virtual vehicle image 50, the driver can easily estimate a turning direction of the towed vehicle image 66 in accordance with behavior of the virtual vehicle image 50.

At S110, if the current control state is the parking assistance mode (Yes at S110), for example, the ECU 14 advances to the flowchart in FIG. 15. If guidance control has not started yet (No at S142), the target-position determiner 34c acquires the target parking position N from a result of imaging by the imagers 15 and a result of the detection by the ranging units 16 and 17 (S144). The route calculator 34d calculates the guide route L for guiding the vehicle 1 from a current position (reference point) to the target parking position (S146). The ECU 14 then acquires the peripheral image 46 (overhead image) to be displayed on the screen 8b from the peripheral-image generator 30b (S148). In this case, as illustrated in FIG. 13, the peripheral image 46 is preferably an image including the vehicle image 48 exhibiting a current position of the vehicle 1 and the target parking position N.

As described above with reference to FIG. 13, the vehicle-marker display-position controller 32a causes the virtual vehicle image 50 to travel along the guide route L (S150), and determines whether the virtual vehicle image 50 reaches a gear shifting position (the turn-back point, the point to watch for) (S152). When the virtual vehicle image 50 reaches the gear shifting position (Yes at S152), the vehicle-marker display-position controller 32a stops moving display of the virtual vehicle image 50. The display-mode controller 32b displays the virtual vehicle image 50 in a gear shifting mode as the display mode (S154). For example, the display color of the virtual vehicle image 50 is changed from green in regular setting to red for calling attention. The display-mode controller 32b may also change the state of the virtual vehicle image 50 from the non-blinking state in regular setting to the blinking state for calling attention. In this case, the ECU 14 may output a voice message to change the gearshift 7 from the voice output device 9. During this process, the vehicle 1 (driver) automatically or manually moves to the gear shifting position. In this case, from the virtual vehicle image 50 displayed in a highlighted manner, the driver can easily recognize a position and timing of temporary stop and gear-shifting. The driver can easily understand the positional relationship during the parking assistance from the display of the virtual vehicle image 50 and the other vehicles 52a and 52b in the overhead mode.

If the vehicle-state acquirer 34b confirms the operation of the gearshift 7 to change the shift position (Yes at S156), the ECU 14 temporarily advances the processing to S110 to check continuance of the parking assistance mode. That is, when the driver decides not to park although moving the vehicle 1 to the gear shifting point, the processing proceeds to S112, display processing of the virtual vehicle image 50. In response to continuance of the parking assistance mode, the processing proceeds to S142 in which guidance control has been already started (Yes at S142), and proceeds to S150, skipping S144 to S148 to continue traveling display of the virtual vehicle image 50. If the virtual vehicle image 50 does not reach the gear shifting position on display at S152 (No at S152), the ECU 14 advances to S158, skipping S154 and S156.

With no change in the shift position at S156 (No at S156), the vehicle-marker display-position controller 32a checks whether the virtual vehicle image 50 reaches the target parking position N on display (S158). If the virtual vehicle image 50 does not reach the target parking position N on display (No at S158), the processing proceeds to S110, as described above, and the vehicle-marker display-position controller 32a continues to control display of the virtual vehicle image 50 while checking continuance of the parking assistance. If the virtual vehicle image 50 reaches the target parking position N on display (Yes at S158), the vehicle-marker display-position controller 32a stops moving the display of the virtual vehicle image 50 at the target parking position N. The display-mode controller 32b displays the virtual vehicle image 50 in a stop mode (S160). For example, the display-mode controller 32b changes the state of the virtual vehicle image 50 to the blinking state while maintaining the display color thereof in green in regular setting. With such display of the virtual vehicle image 50, the driver can easily recognize that the vehicle 1 can reach the target parking position N if guiding the vehicle 1 at the current steering angle. The guidance controller 34e checks whether the vehicle 1 reaches the target parking position N (S162). If the vehicle 1 has not reached the target parking position N yet (No at S162), guidance controller 34e continues to perform display at S160. If the vehicle 1 reaches the target parking position N (Yes at S162), the processing ends. In this case, the ECU 14 may allow the voice controller 14e to output a voice message representing completion of the parking assistance from the voice output device 9. The ECU 14 may allow the display controller 14d to display a text message representing completion of the parking assistance on the display device 8. After elapse of a given period, the ECU 14 may return the display of the display device 8 to regular display such as a navigation screen or an audio screen.

In this way, the periphery monitoring system 100 according to the present embodiment displays the virtual vehicle image 50 in the overhead mode. Consequently, this can provide the driver with the display in such a manner that the driver can intuitively recognize a future moving position of the vehicle 1, a future orientation of the vehicle 1, and a future positional relationship between the vehicle 1 and the object to watch for (for example, another vehicle 52), when the vehicle 1 travels at the current steering angle. This results in abating the driver's sense of insecurity, and makes it easier for the driver to make appropriate driving determination, which contributes to reducing a driving load.

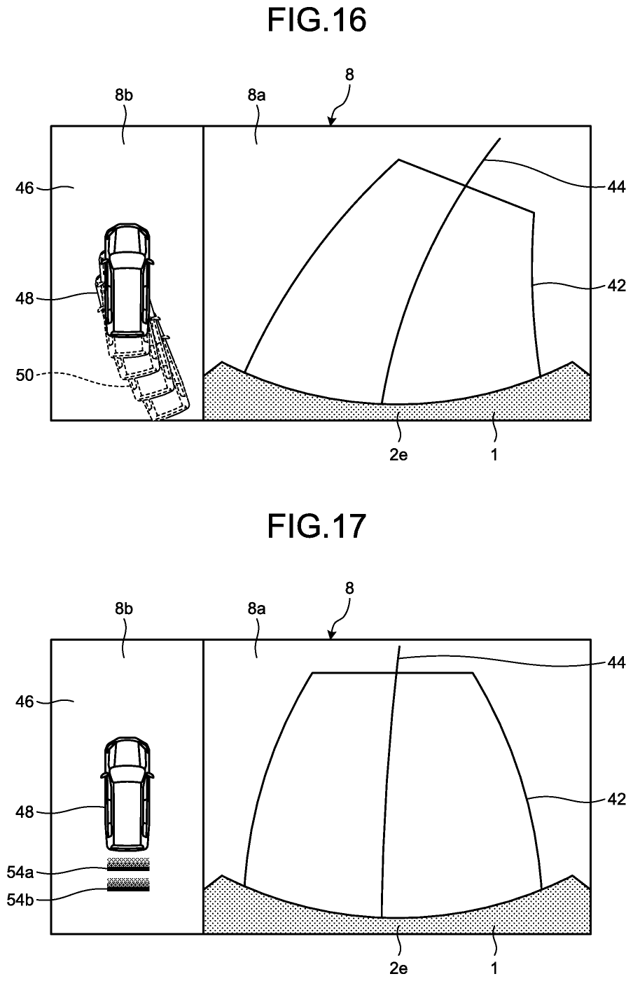

FIG. 16 is a diagram illustrating another exemplary display of the virtual vehicle image 50 in the first display mode illustrated in FIG. 6. In the example illustrated in FIG. 6, one virtual vehicle image 50 (virtual icon) is moving to a position corresponding to the position of the vehicle 1 traveling backward at the current steering angle by three meters, for example, (traveling backward by a given distance). In the example illustrated in FIG. 16, the virtual vehicle image 50 is displayed as afterimages at regular intervals, for example, so as to clearly display a trajectory of the virtual vehicle image 50 traveling backward by three meters, for example, from the position of the vehicle image 48 at the current steering angle of the vehicle 1. That is, by displaying afterimages of the virtual vehicle image 50, the driver can intuitively and more easily recognize how the vehicle 1 will move in the future. With an obstacle located around the vehicle 1 (vehicle image 48), the driver can more easily recognize the positional relationship between the obstacle and the afterimages of the virtual vehicle image 50 at each position. Further, situation that the virtual vehicle image 50 is approaching the obstacle can be displayed in detail, i.e., the positional relationship between the obstacle and the afterimages of the virtual vehicle images 50 is continuously displayed. As a result, for example, this can facilitate determination on when to change the route (steering angle) to prevent the vehicle 1 from excessively approaching the obstacle, as compared with display of one virtual vehicle image 50 moving, for example.

As illustrated in FIG. 16, in displaying the afterimages of the virtual vehicle image 50, the display mode of the virtual vehicle image 50 may be changed in accordance with a distance to the obstacle. For example, when a relative distance to the obstacle is equal to or smaller than a given value, the display color of the virtual vehicle image 50 may turn to yellow or red, for example, or the non-blinking state and the blinking state thereof may be changed. In this case, by maintaining the display of the afterimage of the virtual vehicle image 50 in the same color (for example, yellow or red), the driver can continuously know how the vehicle is approaching the obstacle. As illustrated in FIG. 16, the display of the afterimages of the virtual vehicle image 50 may be stopped at the position of the alarm line 54, as in the example illustrated in FIG. 8.

In displaying the virtual vehicle images 50 in an afterimage display mode as illustrated in FIG. 16, transmittance of each of the virtual vehicle images 50 may be increased as compared with displaying one virtual vehicle image 50 as illustrated in FIG. 6, for example. In this case, with another display element such as an obstacle located around the vehicle image 48, the display element can be prevented from lowering in visibility. The number of afterimages of the virtual vehicle image 50 can be appropriately changed through initial setting or a driver's operation, for example. In this case, the display intervals of the afterimages of the virtual vehicle image 50 may be set to every 0.3 or 0.5 meter, for example in accordance with the number of afterimages to display. FIG. 16 illustrates that the vehicle 1 (vehicle image 48) travels backward. However, the afterimages of the virtual vehicle image 50 may be similarly displayed while the vehicle 1 (vehicle image 48) travels forward. In this case, for example, to exit the vehicle, the driver can easily check a moving route so that the vehicle 1 comes into no contact with another neighboring vehicle or an obstacle. This makes a relative distance to another neighboring vehicle or an obstacle easily recognizable, providing the driver with a sense of safety at the time of actually exiting the vehicle 1.

FIG. 17 is a diagram illustrating another exemplary display of the periphery monitoring system 100 (periphery monitoring device) as an exemplary display of the peripheral image 46 (overhead image) when the current steering angle of the vehicle 1 corresponds to a steering neutral position. While the current steering angle of the vehicle 1 corresponds to the steering neutral position, that is, the vehicle 1 can advance straight, the driver can easily predict a future position of the vehicle 1. In such a case, the vehicle-marker display-position controller 32a may cause the virtual vehicle image 50 not to be displayed, for example. In this case, the estimated motion line 42 and the estimated direction line 44 extend in the lengthwise direction (for example, immediately behind) of the vehicle 1 on the screen 8a displaying the actual image. By non-display of the virtual vehicle image 50, the driver can understand the surrounding environment of the vehicle 1 (vehicle image 48) more easily. Additionally, by not displaying the virtual vehicle image 50 in accordance with the current steering angle of the vehicle 1, the driver can intuitively recognize that the current steering angle of the vehicle 1 corresponds to the steering neutral position, or that the vehicle 1 is movable straight. The features that the virtual vehicle image 50 is not to be displayed when the current steering angle of the vehicle 1 corresponds to the steering neutral position are also applicable to the respective display modes (FIG. 6 to FIG. 11, and FIG. 16, for example) such as the first display mode and the second display mode, attaining the same or similar effects. The steering neutral position is not necessarily defined to be “steering angle=0 degree” as long as it corresponds to the steering angle at which the vehicle 1 can substantially travel straight (travel backward or travel forward). The steering neutral position of the steering 4 (steering wheel) may be defined to be in a given steering range, considering backlash of the steering wheel.

Thus, by not displaying the virtual vehicle image 50 while the current steering angle of the vehicle 1 corresponds to the steering neutral position, the driver can intuitively recognize that the vehicle is movable substantially straight (steering angle=0 degree). Also, the peripheral image displayed in the overhead mode is simplified, enabling the driver to more easily understand the peripheral situation.

In the case of not displaying the virtual vehicle image 50 when the current steering angle of the vehicle 1 corresponds to the steering neutral position, as illustrated in FIG. 17, distance lines 54a and 54b may be displayed as indicators of a distance from the end of the vehicle image 48. For example, the distance line 54a may be displayed at a position at a distance of 0.5 meter, for example, from the end of the vehicle 1 on the peripheral image 46 (overhead image). The distance line 54b may be displayed at a position at a distance of 1.0 m therefrom, for example. Thus, display of the distance lines 54a and 54b in place of the virtual vehicle image 50 enables the driver to intuitively recognize that steering angle=0 degree from the display of the display device 8. Display of the distance lines 54a and 54b makes it easier for the driver to know how far the vehicle 1 can move backward, in the case of moving the vehicle 1 backward straight, for example, to approach a wall behind or to move the vehicle 1 to the rear end of the parking lot. FIG. 17 illustrates the distance lines 54a and 54b with a certain margin and gradually varying (gradated) transmittance in the vehicle longitudinal direction. This improves recognition performance by the display mode (highlighted display) of the distance lines 54a and 54b. If an obstacle is found, the distance lines 54a and 54b are prevented from blocking (hiding) the obstacle, road surface condition, and text or a mark drawn on the road surface. This can reduce deterioration in the recognition performance. FIG. 17 illustrates an example of displaying the two distance lines 54a and 54b, However, the number of lines to display or display interval (a distance from the end of the vehicle 1 (vehicle image 48) to the distance line 54a or the distance line 54b) can be appropriately changed at the time of initial setting or a driver's operation when making a display request.

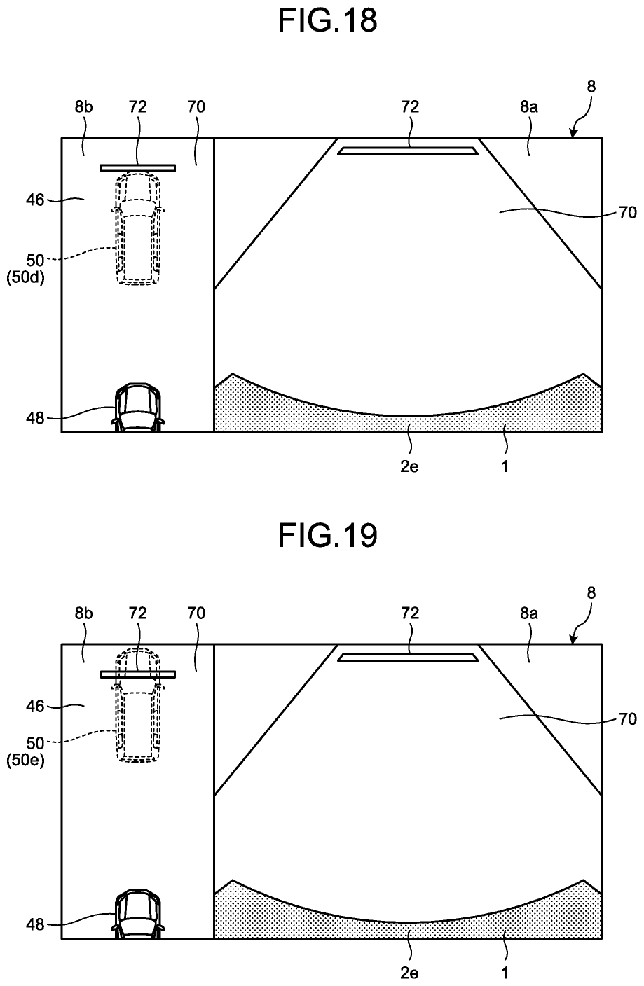

FIG. 18 and FIG. 19 illustrate an exemplary application of the periphery monitoring system 100. As described above, the periphery monitoring system 100 according to the present embodiment can display a future position of the vehicle 1 when traveling at the current steering angle. Thus, in the exemplary application illustrated in FIG. 18 and FIG. 19, the periphery monitoring system 100 estimates a stop position of the vehicle 1 and displays it on the virtual vehicle image 50 when the vehicle 1 brakes during regular traveling.

In regular forward travel, the peripheral-image generator 30b can display an actual frontward image on the screen 8a of the display device 8 according to the image data generated by the imager 15c. When the ECU 14 receives an operation (braking request) of the braking unit 6 (brake pedal) from the brake sensor 18b and the object-to-watch-for acquirer 30d detects a stop line 72 ahead on a road surface 70, the ECU 14 executes a stop-position display mode. In this case, the overhead display controller 32c displays the screen 8b (peripheral image 46) on the display device 8. The vehicle-marker display-position controller 32a displays the vehicle image 48 on the peripheral image 46. The ECU 14 calculates an estimated stop position of the vehicle 1 from a detected value (brake force) by the brake sensor 18b, a vehicle speed of the vehicle 1 based on a detected value by the wheel-speed sensor 22, and deceleration, for example. The vehicle-marker display-position controller 32a acquires a display position of the virtual vehicle image 50 (50d) corresponding to the estimated stop position. FIG. 18 illustrates an exemplary display that a driver's operation amount of the braking unit 6 (force applied to the brake pedal) is appropriate, and the virtual vehicle image 50 (50d) can stop at the stop line 72. FIG. 19 illustrates an exemplary display of the virtual vehicle image 50 (50e), exhibiting that the driver's operation amount of the braking unit 6 (force applied to the brake pedal) is insufficient for stopping the vehicle 1 at the stop line 72, and the vehicle 1 may stop crossing the stop line 72. By the display as illustrated in FIG. 19, the driver can increase the step-on to the brake pedal to correct the state of the vehicle 1 to be able to stop at the stop line 72, as illustrated in FIG. 18, for example. In this case, the virtual vehicle image 50 (50e) may be displayed in a highlighted manner (for example, in red or in a blinking state) for calling attention of the driver.

In displaying the stop position on the virtual vehicle image 50 as illustrated in FIG. 18 and FIG. 19, the virtual vehicle image 50 may continuously move away from the vehicle image 48 in the first display mode. However, it is preferable to notify the driver of whether the vehicle 1 moves across the stop line 72 as soon as possible. Thus, after acquiring the estimated stop position of the virtual vehicle image 50, the vehicle-marker display-position controller 32a may immediately display the virtual vehicle image 50 at the estimated stop position. In a longer braking distance, the vehicle image 48 may be displayed at the bottom end of the screen 8b as illustrated in FIG. 18 and FIG. 19 so that both the vehicle image 48 and the virtual vehicle image 50 can be displayed on the screen 8b. Alternatively, the screen 8b may be decreased in display magnification to display a wider area.

Thus, by displaying the virtual vehicle image 50 promptly, the driver is allowed to increase and decrease braking force appropriately and quickly. Specifically, excessive increase in braking force (sudden braking) is avoidable. With a driver's excessive initial operation amount of the braking unit 6, the virtual vehicle image 50 stops before the stop line 72 on display. Also in this case, displaying the virtual vehicle image 50 in a highlighted manner makes it possible for the driver to recognize excessive braking force and reduce the braking force. Along with the driver's adjustment of the braking force, the display position of the virtual vehicle image 50 may be changed. The ECU 14 may appropriately output a voice message in accordance with the display state of the virtual vehicle image 50. For example, the ECU 14 may output a message such as “Appropriate braking force”, “Insufficient braking force, please step on the brake pedal a little harder”, and “Excessive braking force, please relax braking force a little”. Alternatively, the ECU 14 may output different kinds of annunciation sound to inform the driver of the same or similar messages depending on the display state of the virtual vehicle image 50.

As illustrated in FIG. 13, FIG. 18, and FIG. 19, for example, by displaying the virtual vehicle image 50, control details of the system, that is, the behavior of the vehicle 1 can be presented to the driver when the vehicle 1 travels under automatic control or automatic brake control, for example. This can also contribute to improving the driver's sense of safety.

A display processing program for a virtual vehicle image executed by the CPU 14a according to the embodiment may be recorded and provided in an installable or executable file format on a computer-readable recording medium such as a compact disc read only memory (CD-ROM), a flexible disk (FD), a compact disc recordable (CD-R), and a digital versatile disc (DVD).

The display processing program for a virtual vehicle image may be stored in a computer connected to a network such as the Internet and provided by being downloaded via the network. Furthermore, the display processing program for a virtual vehicle image executed in the present embodiment may be provided or distributed via a network such as the Internet.

Embodiments and modifications of the present invention have been described above for illustrative purpose only and are not intended to limit the scope of the invention. Such novel embodiments may be carried out in a variety of forms, and various omissions, substitutions, and modifications can be made without departing from the spirit of the invention. Such embodiments and modifications are incorporated in the scope and spirit of the invention and are incorporated in the scope of the inventions set forth in the claims and their equivalents.

### EXPLANATIONS OF LETTERS OR NUMERALS

1 VEHICLE
8 DISPLAY DEVICE
8a, 8b SCREEN
14 ECU
14a CPU
15 IMAGER
16, 17 RANGING UNIT
19 STEERING-ANGLE SENSOR
30 ACQUIRER
30a STEERING-ANGLE ACQUIRER
30b PERIPHERAL IMAGE GENERATOR
30c VEHICLE-MARKER ACQUIRER
30d OBJECT-TO-WATCH-FOR ACQUIRER
30e TRAILER COUPLING-ANGLE ACQUIRER
32 CONTROLLER
32a VEHICLE-MARKER DISPLAY-POSITION CONTROLLER
32b DISPLAY-MODE CONTROLLER
32c OVERHEAD DISPLAY CONTROLLER
34 DRIVING ASSIST
34a ROUTE-MARKER ACQUIRER
34b VEHICLE-STATE ACQUIRER
34c TARGET-POSITION DETERMINER
34d ROUTE CALCULATOR
34e GUIDANCE CONTROLLER
36 DISPLAY-SWITCH RECEIVER
38 NOTIFIER
40 OUTPUT
46 PERIPHERAL IMAGE
48 VEHICLE IMAGE
50 VIRTUAL VEHICLE IMAGE
60 TOWED VEHICLE
64 TOWED-VEHICLE DISPLAY REGION
66 TOWED VEHICLE IMAGE
100 PERIPHERY MONITORING SYSTEM

1. A periphery monitoring device comprising:
an acquirer configured to acquire a vehicle image of the vehicle and a peripheral image, the vehicle image being to be displayed on the peripheral image in the overhead mode, the peripheral image representing peripheral situation of a vehicle based on image data output from an imager mounted on the vehicle to image surroundings of the vehicle, and to be displayed in an overhead mode; and
a controller configured to cause a virtual vehicle image to be displayed on the peripheral image together with the vehicle image, the virtual vehicle image representing, in the overhead mode, a state of the vehicle when traveling at a current steering angle.

2. The periphery monitoring device according to claim 1, wherein
the controller causes the virtual vehicle image to be displayed such that the virtual vehicle image travels away from the vehicle image in a direction corresponding to the current steering angle of the vehicle from a superimposed position of the virtual vehicle image and the vehicle image.

3. The periphery monitoring device according to claim 1, wherein
the controller changes orientation of the virtual vehicle image with respect to the vehicle image so as to correspond to orientation of the vehicle traveling at the current steering angle while causing the virtual vehicle image and the vehicle image to be displayed at the superimposed position.

4. The periphery monitoring device according to claim 1, wherein
the acquirer acquires positional information indicating a position of an object to watch for located around the vehicle, and
the controller sets a display stop position of the virtual vehicle image in accordance with the position of the object to watch for.

5. The periphery monitoring device according to claim 4, wherein
the controller sets a display mode of the virtual vehicle image in accordance with a distance to the object to watch for.

6. The periphery monitoring device according to claim 1, wherein
the acquirer acquires a coupling state of a towed vehicle towed by the vehicle with respect to the vehicle, and
the controller causes the virtual vehicle image to be displayed on the peripheral image together with a coupling image representing the coupling state of the towed vehicle.

7. The periphery monitoring device according to claim 1, wherein
after start of traveling of the vehicle, the controller causes the virtual vehicle image to be displayed.

8. The periphery monitoring device according to claim 1, wherein
when the current steering angle of the vehicle corresponds to a steering neutral position, the controller causes the virtual vehicle image not to be displayed.
